(19) United States
(12) Patent Application Publication
(10) Pub. No.: US 2025/0193117 A1
(43) Pub. Date: Jun. 12, 2025

(54) SYSTEMS, METHODS, AND DEVICES FOR DECENTRALIZED DISTRIBUTED COMPUTING

(71) Applicant: Apple Inc., Cupertino, CA (US)

(72) Inventors: Sameh M. ELDESSOKI, Munich (DE); Christian HOFMANN, Munich (DE); Amr Abdelrahman Yousef Abdelrahman MOSTAFA, Munich (DE); Alperen GUNDOGAN, Munich (DE); Ahmed Mohamed Ibrahim HASSAN, Munich (DE); Tarik TABET, Carlsbad, CA (US); Dimitrios ALANIS, Munich (DE); Milan ZIVKOVIC, Munich (DE); Said MEDJKOUH, San Diego, CA (US); Panagiotis BOTSINIS, Munich (DE)

(21) Appl. No.: 18/962,318

(22) Filed: Nov. 27, 2024

Related U.S. Application Data
(60) Provisional application No. 63/608,170, filed on Dec. 8, 2023.

(51) Int. Cl. H04L 47/125; H04W 28/08

(52) U.S. Cl. CPC H04L 47/125; H04W 28/0858

(57) ABSTRACT

Solutions for decentralized distributed computing within a wireless environment. A set of local wireless devices (e.g., user equipment (UE)) can form a subnetwork with each other. The UEs can support various functions to enable compute tasks to be offloaded from some subnetwork devices and performed by other subnetwork devices. The result produced by performing the task can be returned to the devices that offloaded the tasks. A management node of the subnetwork can connect to a base station and/or directly to a management of another subnetwork. Compute tasks can be offloaded from one subnetwork, performed by another subnetwork or a network device (such as the base station or a network server), and the results of the task performed can be returned to the subnetwork that offloaded the task.

### CROSS-REFERENCE TO RELATED APPLICATIONS

This application claims benefit of U.S. Provisional Application No. 63/608,170, filed Dec. 8, 2023, the content of which is incorporated herein by reference in its entirety for all purposes.

### FIELD

This disclosure relates to wireless communication networks and mobile device capabilities.

### BACKGROUND

Wireless communication networks and wireless communication services are becoming increasingly dynamic, complex, and ubiquitous. For example, some wireless communication networks can be developed to implement fourth generation (4G), fifth generation (5G) or new radio (NR) technology. Such technology can include solutions for enabling user equipment (UE) and network devices, such as base stations, to communicate with one another. In some scenarios, such communications can be directed to enabling devices to share resources and perform tasks cooperatively.

### BRIEF DESCRIPTION OF THE DRAWINGS

The present disclosure will be readily understood and enabled by the detailed description and accompanying figures of the drawings. Like reference numerals can designate like features and structural elements. Figures and corresponding descriptions are provided as non-limiting examples of aspects, implementations, etc., of the present disclosure, and references to “an” or “one” aspect, implementation, etc., may not necessarily refer to the same aspect, implementation, etc., and can mean at least one, one or more, etc.

FIG. 1 is a diagram of an example of an overview according to one or more implementations described herein.

FIG. 2 is a diagram of an example network according to one or more implementations described herein.

FIG. 3 is a diagram of an example of decentralized distributed computing within a subnetwork according to one or more implementations described herein.

FIG. 4 is a diagram of an example of functions according to one or more implementations described herein.

FIG. 5 is a diagram of an example of functions and nodes according to one or more implementations described herein.

FIGS. 6-7 are diagrams of examples of node and function arrangements according to one or more implementations described herein.

FIG. 8 is a diagram of an example of functions, nodes, and user equipment (UEs) according to one or more implementations described herein.

FIG. 9 is a diagram of an example of a UE according to one or more implementations described herein.

FIGS. 10-11 are diagrams of examples of UE and node arrangements within a subnetwork according to one or more implementations described herein.

FIG. 12 is a diagram of an example of nodes of a subnetwork according to one or more implementations described herein.

FIGS. 13-14 are diagrams of an example of a process for decentralized distributed computing according to one or more implementations described herein.

FIGS. 15-16 are diagrams of examples of processes for decentralized distributed computing according to one or more implementations described herein.

FIGS. 17-19 are diagrams of examples of processes for decentralized distributed computing according to one or more implementations described herein.

FIG. 20 is a diagram of an example of decentralized distributed computing between subnetworks according to one or more implementations described herein.

FIG. 21 is a diagram of an example of alternatives for decentralized distributed computing between subnetworks according to one or more implementations described herein.

FIG. 22 is a diagram of an example of decentralized distributed computing involving a network server according to one or more implementations described herein.

FIG. 23 is a diagram of an example of network nodes for decentralized distributed computing according to one or more implementations described herein.

FIGS. 24-25 are diagrams of examples of negotiating compute offload control functions according to one or more implementations described herein.

FIGS. 26-27 are diagrams of an example of a process for decentralized distributed computing between subnetworks according to one or more implementations described herein.

FIGS. 28-29 are diagrams of an example of a process for decentralized distributed computing between subnetworks according to one or more implementations described herein.

FIGS. 30-31 are diagrams of an example of a process for decentralized distributed computing between subnetworks according to one or more implementations described herein.

FIG. 32 is a diagram of an example of components of a device according to one or more implementations described herein.

FIG. 33 is a block diagram illustrating components, according to one or more implementations described herein, able to read instructions from a machine-readable or computer-readable medium (e.g., a non-transitory machine-readable storage medium) and perform any one or more of the methodologies discussed herein.

FIG. 34-36 are diagrams of examples of processes for decentralized distributed computing according to one or more implementations described herein.

### DETAILED DESCRIPTION

The following detailed description refers to the accompanying drawings. Like reference numbers in different drawings can identify the same or similar features, elements, operations, etc. Additionally, the present disclosure is not limited to the following description as other implementations can be utilized, and structural or logical changes made, without departing from the scope of the present disclosure.

Telecommunication networks can include user equipment (UEs) capable of communicating with base stations and/or other network access nodes. UEs can also communicate directly with one another via a device-to-device (D2D) connection. UEs and base stations can implement various techniques and communication standards for enabling UEs and base stations to discover one another, establish and maintain connectivity, and exchange information in an ongoing manner. Objectives of such technologies can include enabling devices (e.g., UEs and/or base stations) to share resources and perform tasks cooperatively. This can be referred to as decentralized distributed computing. Generally, distributed computing can include a task associated with a first device (e.g., a UE) being transferred to, and performed by, another device (e.g., another UE) to produce a result that is returned to the first device. Distributed computing can be decentralized in the sense of removing network control from a distributed computing procedure and enabling the control to be deployed by different devices (e.g., devices that are not network nodes).

One or more of the techniques, described herein, can enable decentralized distributed computing within a wireless environment. A set of local wireless devices (e.g., UEs) can form a subnetwork with each other. The UEs can support various functions to enable compute tasks to be offloaded from some subnetwork devices and performed by other subnetwork devices. The result produced by performing the task can be returned to the device that offloaded the task. A management node (MN) of the subnetwork can connect to a base station and/or directly to an MN of another subnetwork. Computing tasks can be offloaded from the subnetwork, performed by another subnetwork or a network device (such as base station or a network server), and the results of the task performed can be returned to the subnetwork that offloaded the task. These and many other features and techniques are described in detail herein.

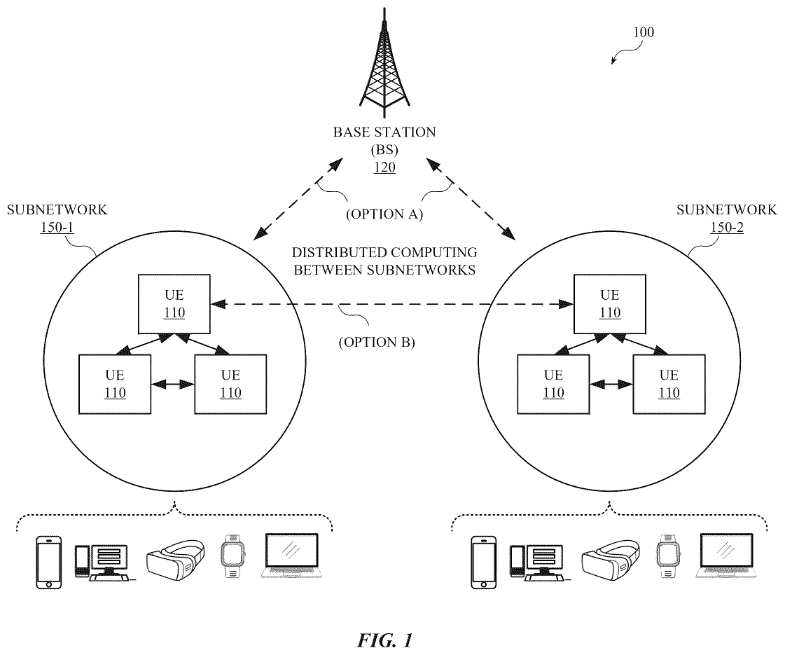

FIG. 1 is a diagram of an example overview 100 of decentralized distributed computing according to one or more implementations described herein. As shown, overview 100 can include a UEs 110 grouped into subnetworks 150-1 and 150-2. The UEs can include a variety of different types of wireless devices, such as smartphones, desktop computers, virtual reality devices, augmented reality devices, wearable devices, and laptop computers. The subnetworks can be connected to base station 120. The subnetworks can also be connected directly to each other. One or more of the techniques described herein can enable UEs 110 to engage in decentralized distributed computing between UEs 110 of the same subnetwork 150, between UEs 110 of different subnetworks 150 via base station 120, and/or between UEs 110 of different subnetworks 150 via direct connection between subnetworks 150-1 and 150-2. Details and examples of these and other features and techniques are described below with reference to the Figures.

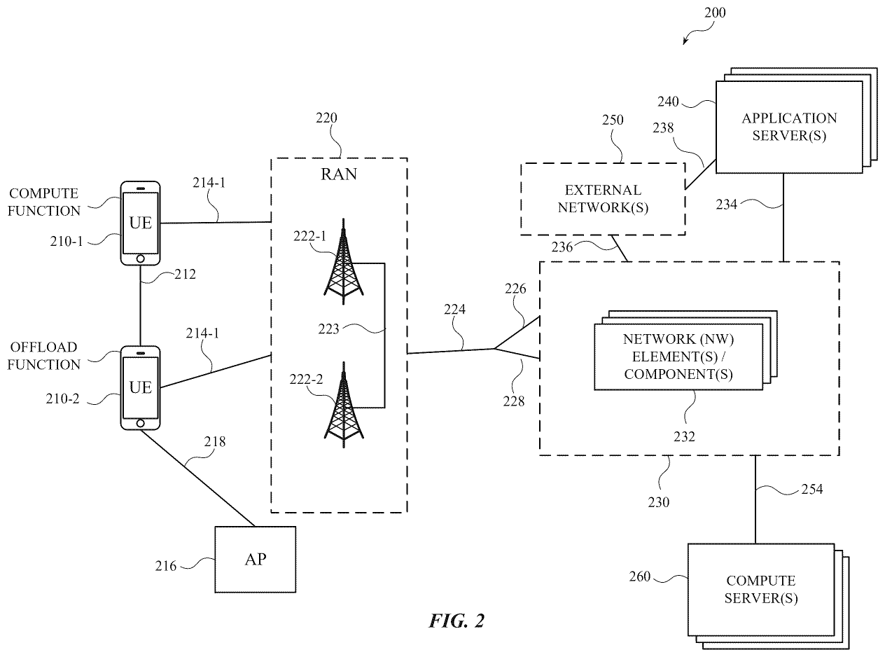

FIG. 2 is an example network 200 according to one or more implementations described herein. Example network 200 can include UEs 210, 210-2, etc. (referred to collectively as “UEs 210” and individually as “UE 210”), a radio access network (RAN) 220, a core network (CN) 230, application servers 240, external networks 250, and compute servers 260.

The systems and devices of example network 200 can operate in accordance with one or more communication standards, such as 3rd generation (3G), 4th generation (4G) (e.g., long-term evolution (LTE)), and/or 5th generation (5G) (e.g., new radio (NR)) communication standards of the 3rd generation partnership project (3GPP). Additionally, or alternatively, one or more of the systems and devices of example network 200 can operate in accordance with other communication standards and protocols discussed herein, including future versions or generations of 3GPP standards (e.g., sixth generation (6G) standards, seventh generation (7G) standards, etc.), institute of electrical and electronics engineers (IEEE) standards (e.g., wireless metropolitan area network (WMAN), etc.), and more.

As shown, UEs 210 can include smartphones (e.g., handheld touchscreen mobile computing devices connectable to one or more wireless communication networks). Additionally, or alternatively, UEs 210 can include other types of mobile or non-mobile computing devices capable of wireless communications, such as personal data assistants (PDAs), pagers, laptop computers, desktop computers, wireless handsets, etc. In some implementations, UEs 210 can include internet of things (IoT) devices (or IoT UEs) that can comprise a network access layer designed for low-power IoT applications utilizing short-lived UE connections. Additionally, or alternatively, an IoT UE can utilize one or more types of technologies, such as machine-to-machine (M2M) communications or machine-type communications (MTC) (e.g., to exchanging data with an MTC server or other device via a public land mobile network (PLMN)), proximity-based service (ProSe) or device-to-device (D2D) communications, sensor networks, IoT networks, and more. Depending on the scenario, an M2M or MTC exchange of data can be a machine-initiated exchange, and an IoT network can include interconnecting IoT UEs (which can include uniquely identifiable embedded computing devices within an Internet infrastructure) with short-lived connections. In some scenarios, IoT UEs can execute background applications (e.g., keep-alive messages, status updates, etc.) to facilitate the connections of the IoT network.

UEs 210 can communicate and establish a connection with one or more other UEs 210 via one or more wireless channels 212, each of which can comprise a physical communications interface/layer. The connection can include an M2M connection, MTC connection, D2D connection, SL connection, etc. The connection can involve a PC5 interface. In some implementations, UEs 210 can be configured to discover one another, negotiate wireless resources between one another, and establish connections between one another, without intervention or communications involving RAN node 222 or another type of network node. In some implementations, discovery, authentication, resource negotiation, registration, etc., can involve communications with RAN node 222 or another type of network node.

Various techniques for communication between and among UEs 210 in furtherance of offloading or computing operations are within the scope of the present disclosure. As described herein, in an example, UE 210 can communicate with RAN node 222 to request SL resources. RAN node 222 can respond to the request by providing UE 210 with a dynamic grant (DG) or configured grant (CG) regarding SL resources. The UE 210 can communicate with RAN node 222 using a licensed frequency band and communicate with the other UE 210 using an unlicensed or licensed frequency band. In another example, UEs 210 can communicate directly without involvement of RAN node 222, such as through resource pools, etc.

UEs 210 can communicate and establish a connection with (e.g., be communicatively coupled) with RAN 220, which can involve one or more wireless channels 214-1 and 214-2, each of which can comprise a physical communications interface/layer. In some implementations, a UE can be configured with dual connectivity (DC) as a multi-radio access technology (multi-RAT) or multi-radio dual connectivity (MR-DC), where a multiple receive and transmit (Rx/Tx) capable UE can use resources provided by different network nodes (e.g., 222-1 and 222-2) that can be connected via non-ideal backhaul (e.g., where one network node provides NR access and the other network node provides either E-UTRA for LTE or NR access for 5G). In such a scenario, one network node can operate as a master node (MN) and the other as the secondary node (SN). The MN and SN can be connected via a network interface, and at least the MN can be connected to the CN 230. Additionally, at least one of the MN or the SN can be operated with shared spectrum channel access, and functions specified for UE 210 can be used for an integrated access and backhaul mobile termination (IAB-MT). Similar for UE 210, the IAB-MT can access the network using either one network node or using two different nodes with enhanced dual connectivity (EN-DC) architectures, new radio dual connectivity (NR-DC) architectures, or the like. In some implementations, a base station (as described herein) can be an example of network node 222. In some scenarios, RAN 120 can coordinate with core network 130 via interfaces 124, 126, and/or 128

As shown, UE 210 can also, or alternatively, connect to access point (AP) 216 via connection interface 218, which can include an air interface enabling UE 210 to communicatively couple with AP 216. AP 216 can comprise a wireless local area network (WLAN), WLAN node, WLAN termination point, etc. The connection 216 can comprise a local wireless connection, such as a connection consistent with any IEEE 702.11 protocol, and AP 216 can comprise a wireless fidelity (Wi-Fi®) router or other AP. While not explicitly depicted in FIG. 2, AP 216 can be connected to another network (e.g., the Internet) without connecting to RAN 220 or CN 230.

RAN 220 can include one or more RAN nodes 222-1 and 222-2 (referred to collectively as RAN nodes 222, and individually as RAN node 222) that enable channels 214-1 and 214-2 to be established between UEs 210 and RAN 220. RAN nodes 222 can include network access points configured to provide radio baseband functions for data and/or voice connectivity between users and the network based on one or more of the communication technologies described herein (e.g., 2G, 3G, 4G, 5G, WiFi, etc.). As examples therefore, a RAN node can be an E-UTRAN Node B (e.g., an enhanced Node B, eNodeB, eNB, 4G base station, etc.), a next generation base station (e.g., a 5G base station, NR base station, next generation eNBs (gNB), etc.). RAN nodes 222 can include a roadside unit (RSU), a transmission reception point (TRxP or TRP), and one or more other types of ground stations (e.g., terrestrial access points). In some scenarios, RAN node 222 can be a dedicated physical device, such as a macrocell base station, and/or a low power (LP) base station for providing femtocells, picocells or the like having smaller coverage areas, smaller user capacity, or higher bandwidth compared to macrocells.

Some or all of RAN nodes 222, or portions thereof, can be implemented as one or more software entities running on server computers as part of a virtual network, which can be referred to as a centralized RAN (CRAN) and/or a virtual baseband unit pool (vBBUP). In these implementations, the CRAN or vBBUP can implement a RAN function split, such as a packet data convergence protocol (PDCP) split wherein radio resource control (RRC) and PDCP layers can be operated by the CRAN/vBBUP and other Layer 2 (L2) protocol entities can be operated by individual RAN nodes 222; a media access control (MAC)/physical (PHY) layer split wherein RRC, PDCP, radio link control (RLC), and MAC layers can be operated by the CRAN/vBBUP and the PHY layer can be operated by individual RAN nodes 222; or a “lower PHY” split wherein RRC, PDCP, RLC, MAC layers and upper portions of the PHY layer can be operated by the CRAN/vBBUP and lower portions of the PHY layer can be operated by individual RAN nodes 222. This virtualized framework can allow freed-up processor cores of RAN nodes 222 to perform or execute other virtualized applications.

In some implementations, an individual RAN node 222 can represent individual gNB-distributed units (DUs) connected to a gNB-control unit (CU) via individual F1 or other interfaces. In such implementations, the gNB-DUs can include one or more remote radio heads or radio frequency (RF) front end modules (RFEMs), and the gNB-CU can be operated by a server (not shown) located in RAN 220 or by a server pool (e.g., a group of servers configured to share resources) in a similar manner as the CRAN/vBBUP. Additionally, or alternatively, one or more of RAN nodes 222 can be next generation eNBs (i.e., gNBs) that can provide evolved universal terrestrial radio access (E-UTRA) user plane and control plane protocol terminations toward UEs 210, and that can be connected to a 5G core network (5GC) 230 via an NG interface.

Any of the RAN nodes 222 can terminate an air interface protocol and can be the first point of contact for UEs 210. In some implementations, any of the RAN nodes 222 can fulfill various logical functions for the RAN 220 including, but not limited to, radio network controller (RNC) functions such as radio bearer management, uplink and downlink dynamic radio resource management and data packet scheduling, and mobility management. UEs 210 can be configured to communicate using orthogonal frequency-division multiplexing (OFDM) communication signals with each other or with any of the RAN nodes 222 over a multicarrier communication channel in accordance with various communication techniques, such as, but not limited to, an OFDMA communication technique (e.g., for downlink communications) or a single carrier frequency-division multiple access (SC-FDMA) communication technique (e.g., for uplink and ProSe or sidelink (SL) communications), although the scope of such implementations may not be limited in this regard. The OFDM signals can comprise a plurality of orthogonal subcarriers.

One or more of the techniques, described herein, can enable decentralized distributed computing within a wireless environment. A set of local wireless devices (e.g., UEs 210) can form a subnetwork with each other. UEs 210 can support various functions to enable compute tasks to be offloaded from come subnetwork devices and performed by other subnetwork devices. The result produced by performing the task can be returned to the device that offloaded the task. An MN of the subnetwork can connect to base station 222 and/or directly to an MN of another subnetwork. Computing tasks can be offloaded from the subnetwork, performed by another subnetwork or a network device (such as base station 222, compute servers 260, application servers 240, and/or one or more other types of network devices), and the results of the task performed can be returned to the subnetwork that offloaded the task. These and many other features are techniques are described in detail herein.

The RAN nodes 222 can be configured to communicate with one another via interface 223. In implementations where the system is an LTE system, interface 223 can be an X2 interface. In NR systems, interface 223 can be an Xn interface. The X2 interface can be defined between two or more RAN nodes 222 (e.g., two or more eNBs/gNBs or a combination thereof) that connect to evolved packet core (EPC) or CN 230, or between two eNBs connecting to an EPC. In some implementations, the X2 interface can include an X2 user plane interface (X2-U) and an X2 control plane interface (X2-C). The X2-U can provide flow control mechanisms for user data packets transferred over the X2 interface and can be used to communicate information about the delivery of user data between eNBs or gNBs. For example, the X2-U can provide specific sequence number information for user data transferred from a master eNB (MeNB) to a secondary eNB (SeNB); information about successful in sequence delivery of PDCP packet data units (PDUs) to a UE 210 from an SeNB for user data; information of PDCP PDUs that were not delivered to a UE 210; information about a current minimum desired buffer size at the SeNB for transmitting to the UE user data; and the like. The X2-C can provide intra-LTE access mobility functionality (e.g., including context transfers from source to target eNBs, user plane transport control, etc.), load management functionality, and inter-cell interference coordination functionality.

As shown, RAN 220 can be connected (e.g., communicatively coupled) to CN 230. CN 230 can comprise a plurality of network elements 232, which are configured to offer various data and telecommunications services to customers/subscribers (e.g., users of UEs 210) who are connected to the CN 230 via the RAN 220. In some implementations, CN 230 can include an evolved packet core (EPC), a 5G CN, and/or one or more additional or alternative types of CNs. The components of the CN 230 can be implemented in one physical node or separate physical nodes including components to read and execute instructions from a machine-readable or computer-readable medium (e.g., a non-transitory machine-readable storage medium). In some implementations, network function virtualization (NFV) can be utilized to virtualize any or all the above-described network node roles or functions via executable instructions stored in one or more computer-readable storage mediums (described in further detail below). A logical instantiation of the CN 230 can be referred to as a network slice, and a logical instantiation of a portion of the CN 230 can be referred to as a network sub-slice. Network Function Virtualization (NFV) architectures and infrastructures can be used to virtualize one or more network functions, alternatively performed by proprietary hardware, onto physical resources comprising a combination of industry-standard server hardware, storage hardware, or switches. In other words, NFV systems can be used to execute virtual or reconfigurable implementations of one or more EPC components/functions.

As shown, CN 230, application servers 240, and external networks 250 can be connected to one another via interfaces 234, 236, 238, and 254, which can include IP network interfaces. Application servers 240 can include one or more server devices or network elements (e.g., virtual network functions (VNFs) offering applications that use IP bearer resources with CM 230 (e.g., universal mobile telecommunications system packet services (UMTS PS) domain, LTE PS data services, etc.). Application servers 240 can also, or alternatively, be configured to support one or more communication services (e.g., voice over IP (VOIP sessions, push-to-talk (PTT) sessions, group communication sessions, social networking services, etc.) for UEs 210 via the CN 230. Similarly, external networks 250 can include one or more of a variety of networks, including the Internet, thereby providing the mobile communication network and UEs 210 of the network access to a variety of additional services, information, interconnectivity, and other network features.

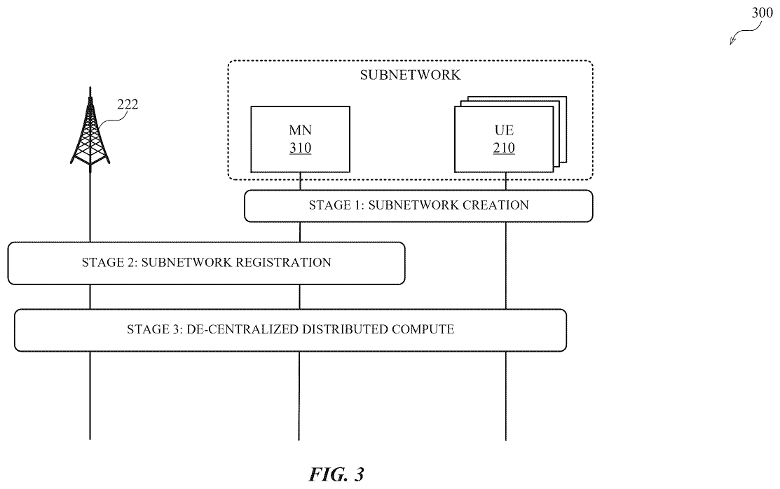

FIG. 3 is a diagram of an example 300 of decentralized distributed computing within a subnetwork according to one or more implementations described herein. As shown, example 300 can include UEs 210, base station 222, and MN 310. MN 310 can include a UE 210 or another type of wireless device. In stage 1, MN 310 can communicate with local UEs 210 to create a subnetwork. Thus, the subnetwork can include multiple local nodes, such as a smartphone, laptop computer, wearable device (e.g., a wireless necklace, watch, etc.), and/or one or more other types of UEs 210. MN 310 can generate and communicate control plane and user plane information to create the subnetwork and enable decentralized distributed computing within the subnetwork. MN 310 can use a variety of frequency ranges to communicate with other UE 210, including high-frequency spectrum bands (e.g., frequencies of the terahertz (THz) band (e.g., frequencies between 0.3 to 3.0 THz)).

In stage 2, MN 310 can communicate with base station 222 to register the subnetwork with base station 222. Creating the subnetwork can enable decentralized distributed computing among the UEs 210 of the subnetwork and reregistering the subnetwork with base station 222 can enable decentralized distributed computing, in stage 3, between UEs 210 of different subnetworks (not shown). In some implementations, UEs 210 of different subnetwork can engage in decentralized distributed computing directly (e.g., without base station 222 functioning as an information relay or intermediary). Details and examples of these features are discussed in greater detail below with reference to the Figures that follow.

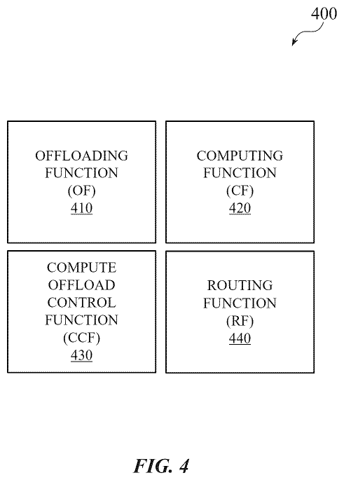

FIG. 4 is a diagram of an example 400 of functions according to one or more implementations described herein. As shown, example 400 can include offloading function (OF) 410, computing function (CF) 420, compute offload control function (CCF) 430, and routing function (RF) 440. One or more of functions 410-440 can be referred to as a node instead of a function. For example, OF 410 can be referred to as offloading node 420, which can indicate a device (e.g., UE 210) executing or performing the offloading function. Thus, functions 410-440 can be implemented by one or more UEs 210 of a subnetwork.

OF 410 can include a set of operations performed by UE 210 to identify a task to be offloaded to another UE 210. The task can be a computational task that can involve the reception, processing, or computing, and/or communication of one or more types of information. Offloading a task can cause the task to be performed by the UE 210 to which the task is offloaded. The UE 210 receiving the task can include a CF 420 that enables the UE 210 to receive the task, perform the task, and return a result of performing the task to the OF 410.

CCF 430 can include set of operations that control whether, which, and when tasks are offloaded from OF 410 to a CF 420. CCF 430 can collect information about the compute capabilities of UEs 210 of the subnetwork, receive and evaluate requests to offload tasks, and prevent, cause, or enable the offloading of tasks by OF 410 to a CF 420. RF 440 can include a set of operations that enables communication between functions 410-430. For example, RF 440 can enable CCF 430 collect UE capability information from UEs 210 within the subnetwork, enable and manage the offloading of a task from OF 410 to CF 420, and/or enable or manage a response or result of computing the task to be sent from CF 420 to OF 410.

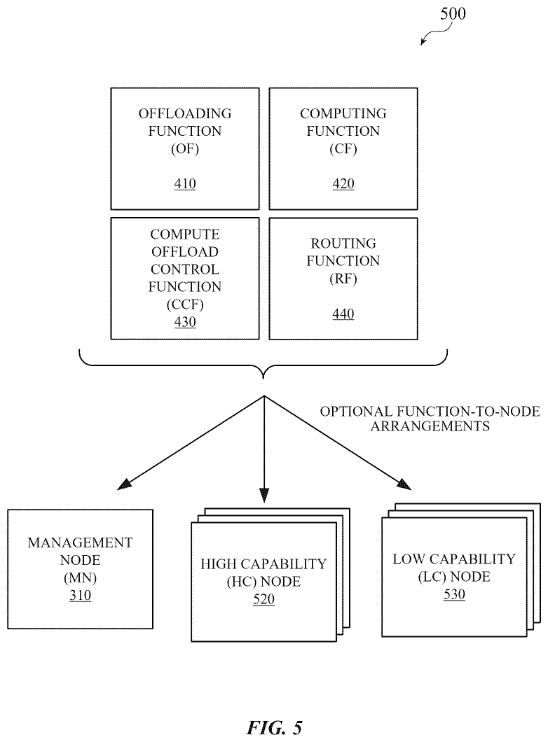

FIG. 5 is a diagram of an example 500 of functions and nodes according to one or more implementations described herein. As shown, example 500 can include functions 410-440, which can be performed by one or more of different combinations of MN 310, one or more high-capability (HC) nodes 520, and one or more low capability (LC) nodes 530. MN 310 is described above with reference to FIG. 3. Whether a device of a subnetwork is a HC node 520 or a LC node 530 can depend on resources available to the device (e.g., processing capacity, memory capacity, storage capacity, wireless communications capabilities, etc.). Devices with relatively substantial resources can be HC nodes 520, and devices with relatively few resources can be LC nodes 530. MN 310 can be a HC node, and HC nodes 520 and LC nodes 530 can or may not be directly connected to a base station. As shown in the examples described below, different arrangements of MNs 310, HC nodes 520, and/or LC nodes 530 can perform one or more of functions 410-440.

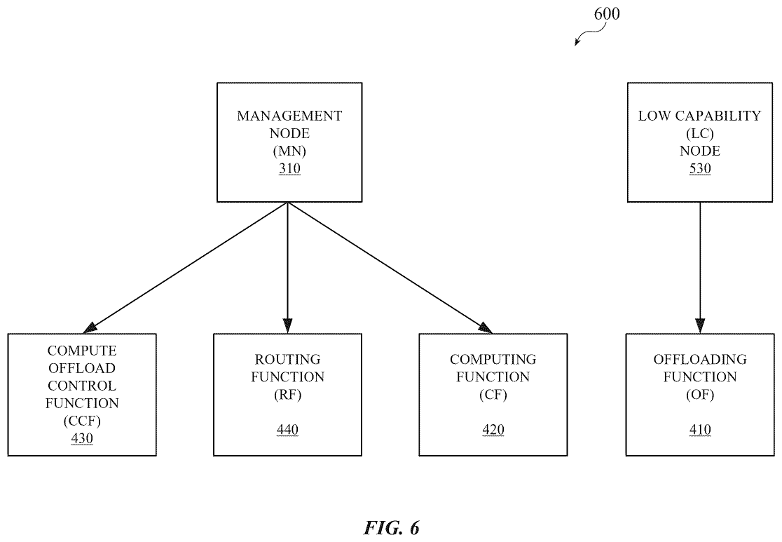

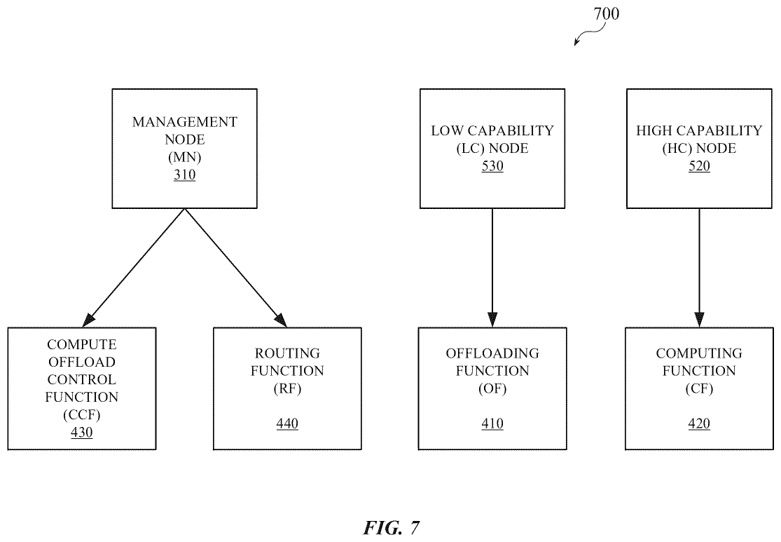

FIGS. 6-7 are diagrams of examples 600 and 700 of nodes and function arrangements according to one or more implementations described herein. Referring to FIG. 6, MN 310 can be configured to perform CCF 430, RF 440, and CF 420. LC 530 can be configured to perform OF 410. As such, decentralized distributed computing within a subnetwork can occur between MN 310 and LC 530 according to example 600. Referring to FIG. 7, MN 310 can be configured to perform CCF 430 and RF 440. LC 530 can be configured to perform OF 410. HC node 520 can be configured to perform CF 420. Thus, decentralized distributed computing within a subnetwork according to example 700 can occur between LC 530 and HC 520 with control of CCF 430 of MN 310. The techniques described herein also include other arrangements of nodes and functions. In some implementations, functions 410-440 can be performed by HC nodes 520 and LC nodes 530, such that MN 310 does not perform any of functions 400. In some implementations, a function can be performed by more than one node. For example, portions of RF 444 can be performed by different HC nodes. Additionally, or alternatively, a subnetwork can have multiple instances of a type of function. For example, a subnetwork can have multiple LC nodes that are each capable of performing OF 410 and/or multiple HC nodes that are each capable of performing CF 420.

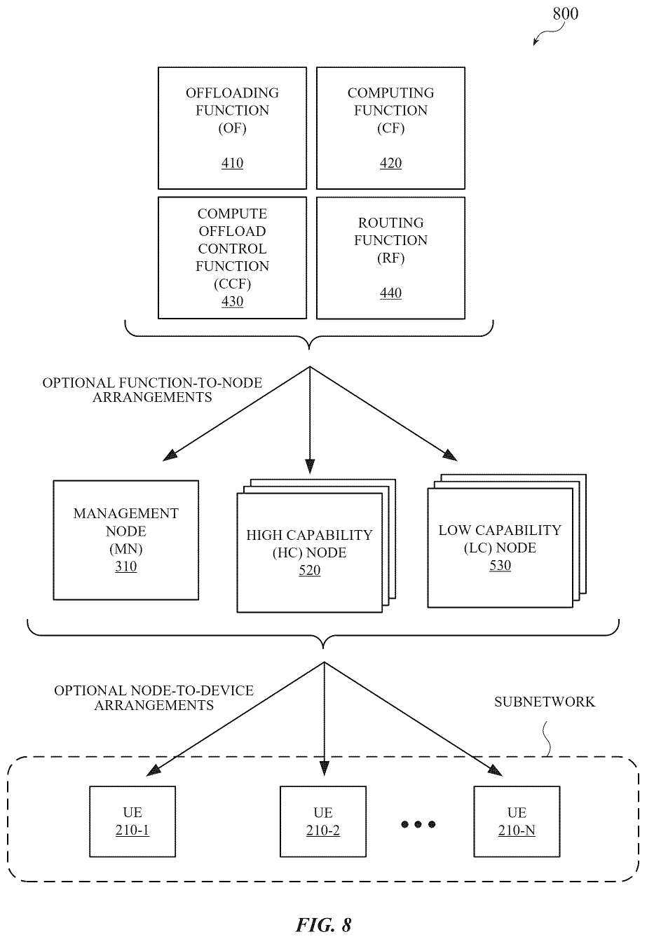

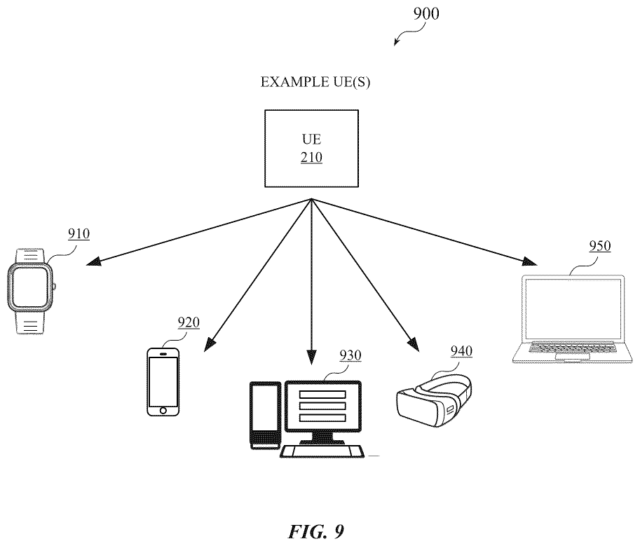

FIG. 8 is a diagram of an example 800 of functions, nodes, and UEs according to one or more implementations described herein. As shown, example 800 can include functions 410-440, which can be performed by one or more of different combinations of MN 310, one or more high-capacity (HC) nodes 520, and one or more low capacity (LC) nodes 530. Similarly, MN 310, HC nodes 520, and LC nodes 530 can be implemented by one or more UEs 210-1, UE 210-2, . . . . UE 210-N (wherein N is greater than or equal to 3) of a subnetwork. FIG. 8 is described with reference to FIGS. 9-12.

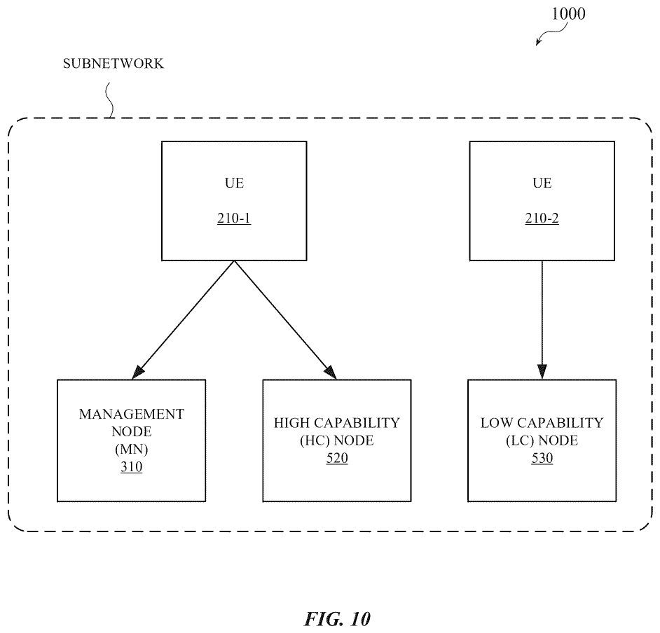

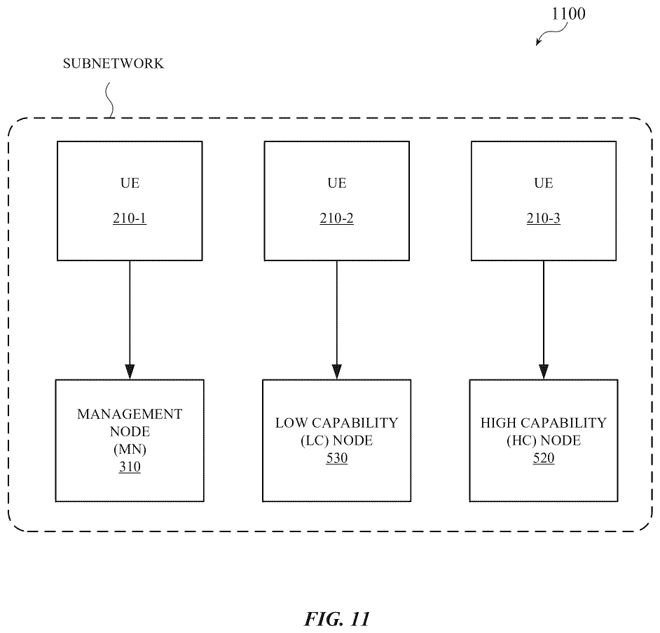

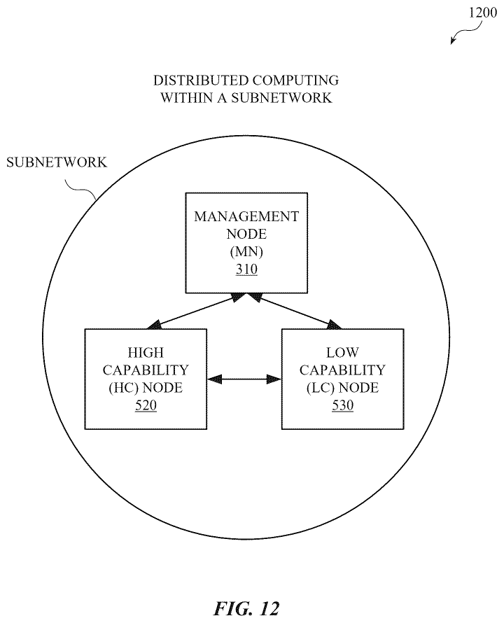

FIG. 9 is a diagram of examples of types of UEs 210 according to one or more implementations described herein. As shown, a UE 210 can include a wearable device (e.g., a wireless necklace, wireless watch, etc.), smartphone, desktop computer, virtual reality system, augment reality system, laptop computer, and more. FIGS. 10-11 are diagrams of examples 1000 and 1100 of UE and node arrangements within a subnetwork according to one or more implementations described herein. Referring to example 1000, a subnetwork can include UE 210-1 and UE 210-2. UE 210-1 can be configured to operate as MN 310 and a HC node 520. UE 210-2 can be configured to operate as a LC node 530. Referring to FIG. 11, a subnetwork can include UE 210-1, UE 210-2, and UE 210-3. UE 210-1 can be configured to operate as MN 310. UE 210-2 can be configured to operate as a LC node 530. UE 210-2 can be configured to operate as a HC node 520. Thus, different UEs 210 can operate as different types of nodes depending on the subnetwork. FIG. 12 is a diagram of an example 1200 of nodes of a subnetwork according to one or more implementations described herein. As shown, subnetwork 1200 can include MN 310, HC node 520, and LC node 530. Each node can be implemented as one or more UEs 210, and each node can support or perform one or more functions 410-440 and communicate with one another to enable decentralized distributed computing.

Collectively, examples 1000, 1100, and 1200 illustrate a non-limiting flexibility and non-limiting variability of configuration for distributed computing with a subnetwork as described herein. Example 1000 illustrates that a single UE 210 can be bother a MN 310 and a HC node 520. Example 1100 illustrates that different UEs 210 can implement different types of nodes (e.g., that MN 310 does not need to be designated or configured to operate as either a HC node 520 or a LC node). Example 1200 illustrates that distributed computing, as described herein, can be implemented as a subnetwork comprising one or more MNs 310, one or more HC nodes 520, and/or one or more LC nodes 530. Each node (310, 520, and 530) can be implemented by a different UE 210 or the same UE 210 (e.g., MN 310 and HC 520).

Referring to FIG. 8, a particular UE 210 can change between operating as MN 310, a HC node 520, and a LC node 530. For example, UE 210 can be a HC node 520 while the UE 210 is in an idle mode or otherwise has a number of resources above a given threshold, but if/when the UE 210 activates local processes that use those resources, the UE 210 can transition to being a LC node 530 for purposes of decentralized distributed computing. Once the local processes are complete and the corresponding resources become available, the UE 210 can transition back again to being a HC node for purposes of decentralized distributed computing. Similarly, one or more functions 410-440 performed by a particular node 310-530 can change. For example, while UE 210 is a HC node 520, the UE 210 can support one or more of CF 420, CCF 430, and RF 440. However, if or when the UE 210 transitions to a LC node 530, the UE 210 can stop supporting one or more of CF 420, CCF 430, and RF 440, and instead support an OF 410 since local resources can have become scarce. Similar changes can occur as UEs 210 enter and/or leave a subnetwork. Thus, the relationship between functions 410-440, nodes 310-530, and UEs 210 can be dynamic.

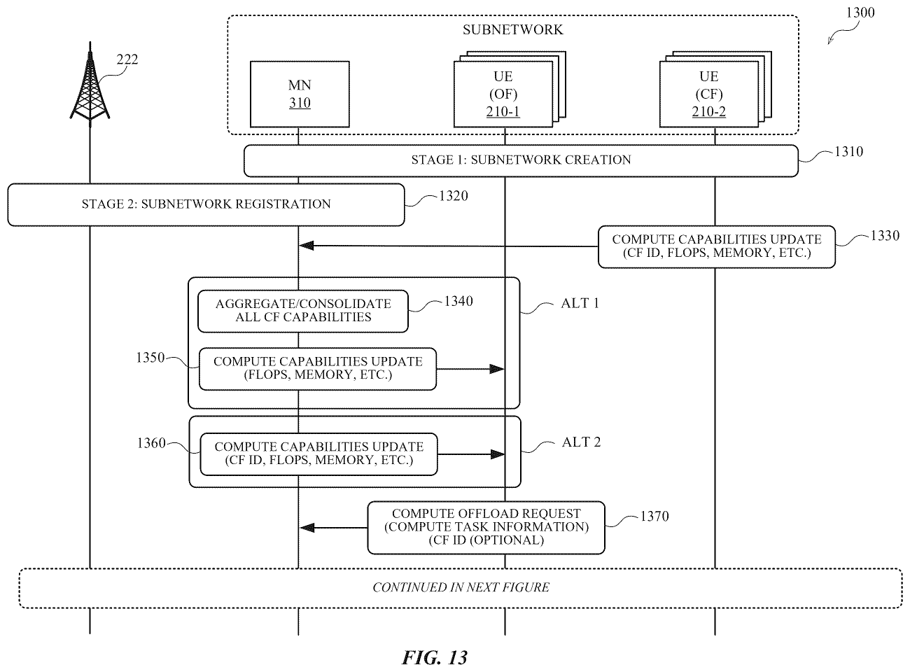

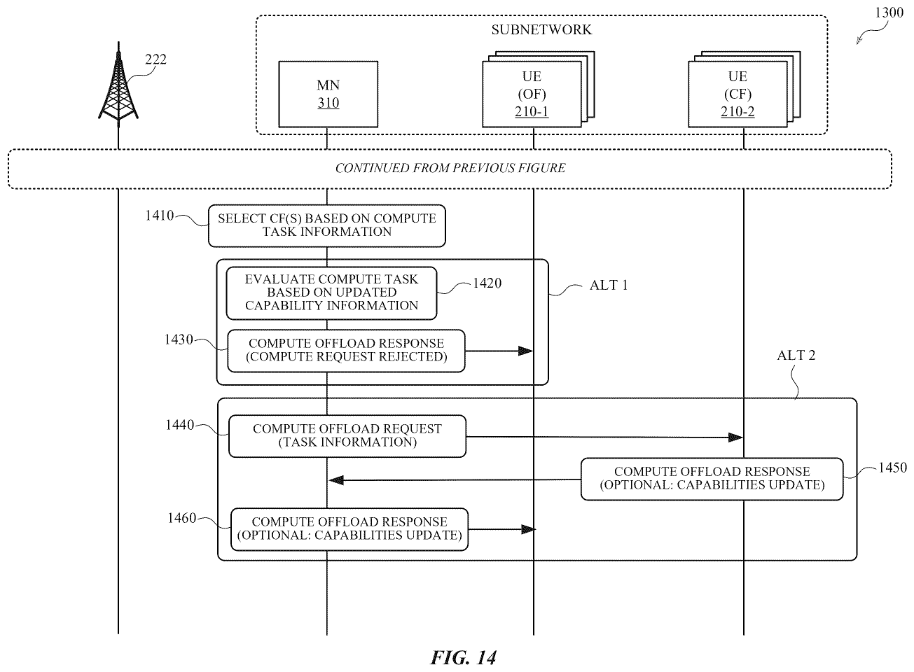

FIGS. 13-14 are diagrams of an example of a process 1300 for decentralized distributed computing according to one or more implementations described herein. Process 1300 can be implemented by base station 222, MN 310, and one or more UEs 210-1 and 210-2. In some implementations, some or all of process 1300 can be performed by one or more other systems or devices, including one or more of the devices of FIG. 2. Additionally, process 1300 can include one or more fewer, additional, differently ordered and/or arranged operations than those shown in FIGS. 13-14. In some implementations, some or all of the operations of process 1300 can be performed independently, successively, simultaneously, etc., of one or more of the other operations of process 1300. As such, the techniques described herein are not limited to the number, sequence, arrangement, timing, etc., of the operations or processes depicted in FIGS. 13-14.

Process 1300 can include a scenario in which a compute offload can be kept within the local subnetwork. The MN 310 of the subnetwork is also the CCF for the subnetwork and there is no involvement from any other CCF. As such, no CCF negotiation is involved in process 1300. As shown, process 1300 can include stage 1 subnetwork creation (at 1310). As described above, this can involve MN 310 communicating with local UEs 210 to create a subnetwork. Process 1300 can also include stage 2 subnetwork registration (at 1320). This can include MN 310 communicating with base station 222 to register the subnetwork with base station 222. While not shown, registering the subnetwork with base station 222 can enable the devices of the subnetwork to engage in decentralized distributed computing that involves one or more other subnetworks. In some implementations, stage 2 can be optional since computation offload is kept within the local subnetwork. In such a scenario, MN 310 can be a private HC node (e.g., a UE 210) configured to offer support to other LC nodes in the subnetwork. Alternatively, MN 310 can be a network or third-party owned HC node configured to support LC nodes in the subnetwork based on a subscription model, for example, which, can be authenticated in stage 1 subnetwork creation (1310) without the involvement of other network or third-party entities (e.g., base station 222, core network 230, application servers 240, compute servers 260, etc.). In such a scenario, computations distribution can be kept within the subnetwork (e.g., within the control of MN 310).

As shown, one or more UEs 210-2 configured with a CF can communicate a compute capabilities update to MN 310 (at 1330). The compute capabilities update can include a CF identifier (ID), a floating-point operations per second (FLOPS), a memory capacity, a processing capacity, and/or one or more types of information regarding the capabilities of UE 210-2 to operate a computing function. In some implementations (alternative 1), process 1500 can include a subnetwork CCF controlled configuration, where MN 310 can aggregate and/or consolidate the CCF compute capabilities within the subnetwork (at 1340). In such scenarios, MN 310 can forward the aggregated and consolidated CF capabilities to UEs 210-1 configured with OFs (at 1350). In other implementations (alternative 2), MN 310 may, without aggregation and consolidation, forward CF capabilities to UEs 210-1 configured with OFs (at 1360).

At some point, UE 210-1 can determine to offload a compute task to one or more CF UEs 210-2. As such, UE 210-1 can send a compute offload request to MN 310 (at 1370). In some implementations, the compute offload request can include one or more types of information relating to the task and/or completion of the task, such as a compute task ID, a CF ID, a battery level compute capacity requirements, a memory requirement, a latency requirement, etc.

MN 310 can select a UE 210-2 configured with a CF to receive the compute task (at 1410). In some. Implementations, MN 310 can evaluate or analyze the compute offload request and/or task information associated with the request, to identify a suitable UE 210-2 for computing the task (at 1420). This can be based on, for example, comparing the compute capabilities information received from UEs 210-2 with the task information or requirements (e.g., a CF ID, a task type, a task ID, time-sensitivity or scheduling requirements of the task, compute capacity requirements, a memory requirement, a latency requirement, etc.). Based on the results of the evaluation (e.g., when there are no suitable UEs 210-2 for the task) MN 310 can send UE 210-1 a compute offload response indicating a rejection of the offload request (1430). Alternatively, the MN 310 can send a compute offload request with appropriate task information to a suitable UE 210-2 (at 1440). UE 210-2 can receive the request, compute the corresponding task, and send MN 310 a compute offload response (at 1450). In some implementations, the response can also include a compute capabilities update regarding UE 210-2. UE 210-1 can receive the compute offload response and forward or relay the compute offload response to UE 210-1. In this manner, process 1300 can provide one or more example solution for decentralized distributed computing.

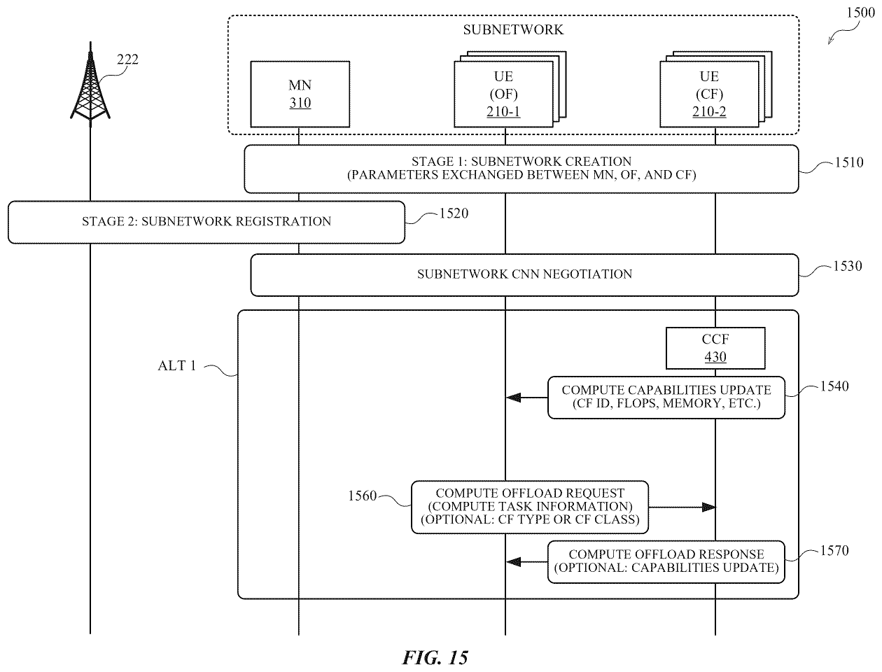

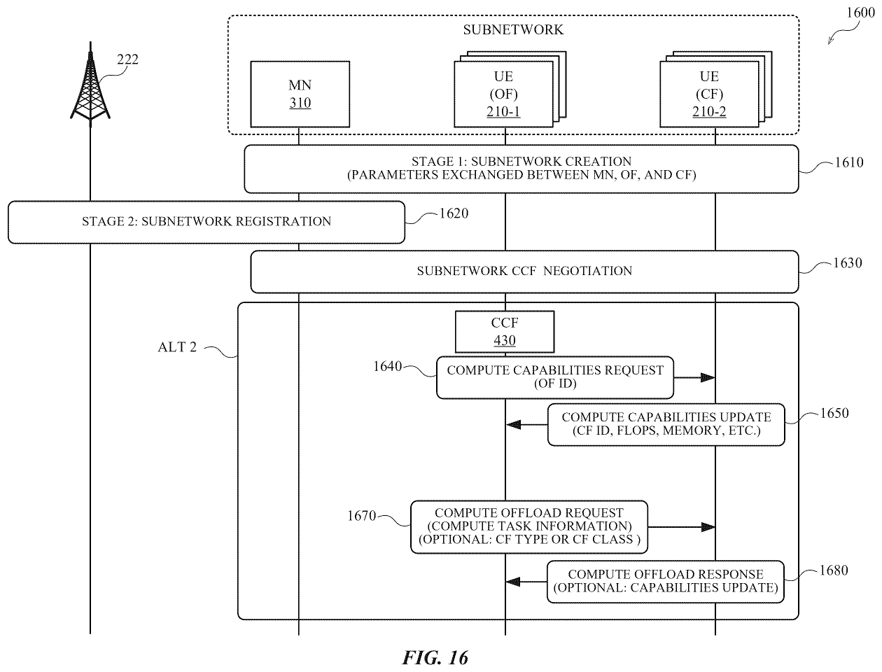

FIGS. 15-16 are diagrams of examples of processes 1500 and 1600 for decentralized distributed computing according to one or more implementations described herein. Processes 1500 and 1600 can be implemented by base station 222, MN 310, and one or more UEs 210-1 and 210-2. In some implementations, some or all of processes 1500 and 1600 can be performed by one or more other systems or devices, including one or more of the devices of FIG. 2. Additionally, processes 1500 and 1600 can include one or more fewer, additional, differently ordered and/or arranged operations than those shown in FIGS. 15-16. In some implementations, some or all of the operations of processes 1500 and 1600 can be performed independently, successively, simultaneously, etc., of one or more of the other operations of processes 1500 and 1600. As such, the techniques described herein are not limited to the number, sequence, arrangement, timing, etc., of the operations or processes depicted in FIGS. 15-16.

Process 1500 can include a scenario in which a compute offload can be kept within the local subnetwork. As described below, process 1500 includes offloading tasks via a direct connection between OF UE 210-1 and CF UE 210-2. For example, the OF UE 210-1 can be wireless glasses within the same subnetwork as a laptop computer, and the wireless glasses directly offload tasks to the laptop for computing. In such a scenario, OF UE 210-1 and CF UE 210-2 can negotiate with one another about which device will run a CCF for the decentralized distributed computing procedure.

As shown, process 1500 can include stage 1 subnetwork creation (at 1510). As described above, this can involve MN 310 communicating with local UEs 210 to create a subnetwork. This can also include an exchange of parameters between MN 310, UE 210-1, and UE 210-2. The parameters can be exchanged between UE 210-1 and UE 210-2 via MN 310, and the parameters can enable a direct connection to be established between UE 210-1 and UE 210-2. Examples of the parameters can include transmit and receive resource pools and discovery resources to allow for direct communication via a sidelink (SL), information to enable communication via listen-before-talk (LBT), or any other proprietary pairing procedure allowing for direct communication between the nodes. Additionally, or alternatively, examples of the parameters can include CCF IDs, device types and classes, etc., for all of the devices in the subnetwork. This can be used by all devices in the subnetwork to populate their respective databases, which can be used later for the direct-connection compute offload procedures.

Process 1500 can also include stage 2 subnetwork registration (at 1520). This can include MN 310 communicating with base station 222 to register the subnetwork with base station 222. While not shown, registering the subnetwork with base station 222 can enable the devices of the subnetwork to engage in decentralized distributed computing that involves one or more other subnetworks. In some implementations, stage 2 can be optional since computation offload is kept within the local subnetwork. In such a scenario, MN 310 can be a private HC node (e.g., a UE 210) configured to offer support to other LC nodes in the subnetwork. Alternatively, MN 310 can be a network or third-party owned HC node configured to support LC nodes in the subnetwork based on a subscription model, for example, which, can be authenticated in stage 1 subnetwork creation (1510) without the involvement of other network or third-party entities (e.g., base station 222, core network 230, application servers 240, compute servers 260, etc.). In such a scenario, computations distribution can be kept within the subnetwork (e.g., within the control of MN 310).

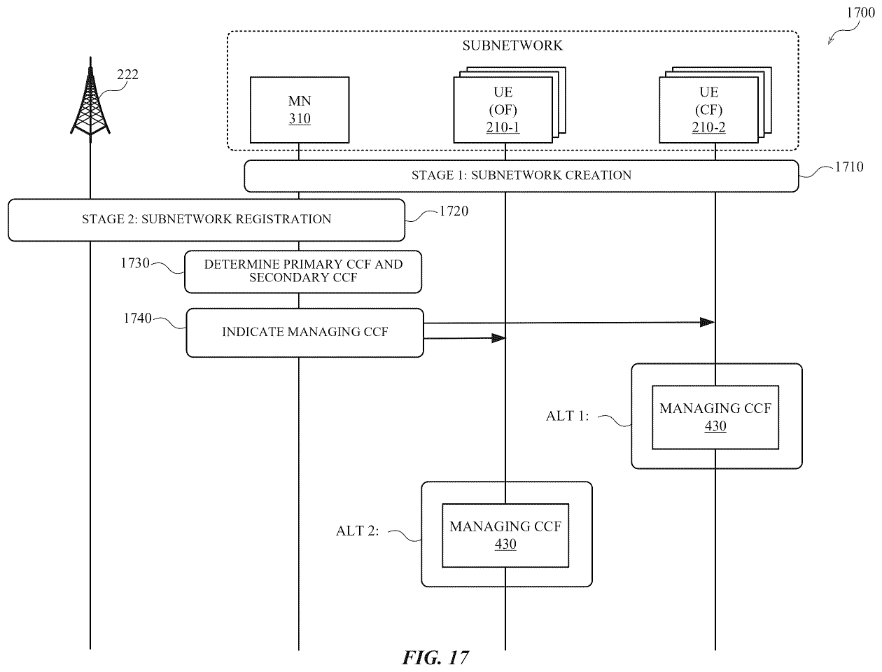

As shown, process 1500 can include MN 310, UE 210-1 and UE 210-2 engaging in negotiations about which device my operate as a CCF for offloading procedures (at 1530). Examples for negotiating which device can operate as a CCF for a subnetwork are discussed below with reference to FIGS. 17-19. Process 1500 can include an alternative (alternative 1) to process 1600 of FIG. 16, as process 1500 can include a scenario in which UE 210-2 is designated as CCF 430 and process 1600 can include a scenario where UE 210-1 is designated as CCF 430.

In some scenarios (e.g., alternative 1) UE 210-2 can be selected to operate as the CCF (430) in addition to operating as a CF 420. In such scenarios, UE 210-2 can communicate a compute capabilities update to UE 210-1. The compute capabilities update can include a CF ID, a FLOPS, a memory capacity, a processing capacity, and/or one or more types of information regarding the capabilities of UE 210-2 to operate a compute function. In some implementations, UE 210-2 can select a CCF (e.g., a CCF ID) for the compute task, which can be based on a comparison of one or more requirements of the tasks and compute capabilities reported by one or more UEs 210-2. UE 210-1 can send a compute offload request to a selected UE 210-2 (at 1560). The request can include compute task information, such as a CF type or CF class, a task type, a task ID, time-sensitivity or scheduling requirements of the task, compute capacity requirements, a memory requirement, a latency requirement, etc.). The CF type or CF class can indicate the type or class of compute function to be applied to the task information. UE 210-2 can receive and complete the compute task and can send a compute offload message response to UE 210-1 (at 1570). The compute offload response can include the results of applying the CF to the task information. In some implementations, UE 210-2 can also send updated capacity or capability information to UE 210-1.

Referring to FIG. 16, process 1600 can include a scenario in which a compute offload can be kept within the local subnetwork. As described below, process 1600 includes offloading tasks via a direct connection between OF UE 210-1 and CF UE 210-2. For example, the OF UE 210-1 can be wireless glasses within the same subnetwork as a laptop computer, and the wireless glasses directly offload tasks to the laptop for computing. In such a scenario, OF UE 210-1 and CF UE 210-2 can negotiated with one another about which device will run a CCF 430 for the decentralized distributed computing procedure.

As shown, process 1600 can include stage 1 subnetwork creation (at 1610). As described above, this can involve MN 310 communicating with local UEs 210 to create a subnetwork. This can also include an exchange of parameters between MN 310, UE 210-1, and UE 210-2. The parameters can be exchanged between UE 210-1 and UE 210-2 via MN 310, and the parameters can enable a direct connection to be established between UE 210-1 and UE 210-2. Examples of the parameters can include transmit and receive resource pools and discovery resources to allow for direct communication via an SL, information to enable communication via listen-before-talk (LBT), or any other proprietary pairing procedure allowing for direct communication between the nodes. Additionally, or alternatively, examples of the parameters can include CCF IDs, device types and classes, etc., for all of the devices in the subnetwork. This can be used by all devices in the subnetwork to populate their respective databases, which can be used later for the direct-connection compute offload procedures.

Process 1600 can also include stage 2 subnetwork registration. This can include MN 310 communicating with base station 222 to register the subnetwork with base station 222 (at 1620). While not shown, registering the subnetwork with base station 222 can enable the devices of the subnetwork to engage in decentralized distributed computing that involves one or more other subnetworks. In some implementations, stage 2 can be optional since computation offload is kept within the local subnetwork. In such a scenario, MN 310 can be a private HC node (e.g., a UE 210) configured to offer support to other LC nodes in the subnetwork. Alternatively, MN 310 can be a network or third-party owned HC node configured to support LC nodes in the subnetwork based on a subscription model, for example, which, can be authenticated in stage 1 subnetwork creation (1610) without the involvement of other network or third-party entities (e.g., base station 222, core network 230, application servers 240, compute servers 260, etc.). In such a scenario, computations distribution can be kept within the subnetwork (e.g., within the control of MN 310).

As shown, process 1600 can include MN 310, UE 210-1 and UE 210-2 engaging in negotiations about which device my operate as a CCF for offloading procedures (at 1630). Examples for negotiating which device can operate as a CCF for a subnetwork are discussed below with reference to FIGS. 17-19. Process 1600 can include an alternative (alternative 2) to process 1500 of FIG. 15, as process 1600 can include a scenario in which UE 210-1 is designated as CCF 430 and process 1500 can include a scenario where UE 210-2 is designated as CCF 430.

In some scenarios (e.g., alternative 2) UE 210-1 can be selected to operate as the CCF (430) in addition to operating as an OF 410. UE 210-1 can communicate a compute capabilities request to UE 210-2, which can include an OF ID (at 1640), and in response UE 210-2 can communicate a compute capabilities update to UE 210-1 (at 1650). The compute capabilities update can include a CF ID, a FLOPS, a memory capacity, a processing capacity, and/or one or more types of information regarding the capabilities of UE 210-2 to operate a compute function. UE 210-1 can send a compute offload request to a selected UE 210-2 (at 1670). The request can include compute task information, such as a CF type or CF class, a task type, a task ID, time-sensitivity or scheduling requirements of the task, compute capacity requirements, a memory requirement, a latency requirement, etc.). The CF type or CF class can indicate the type of compute function to be applied to the task information. UE 210-2 can receive and complete the compute task and can send a compute offload message response to UE 210-1 (at 1680). The compute offload response can include the results of applying the CF to the task information. In some implementations, UE 210-2 can also send updated capacity or capability information to UE 210-1.

FIGS. 17-19 are diagrams of examples of processes 1700, 1800, and 1900 for decentralized distributed computing according to one or more implementations described herein. Processes 1700, 1800, and 1900 can be implemented by base station 222, MN 310, and one or more UEs 210-1 and 210-2. In some implementations, some or all of 1700, 1800, and 1900 can be performed by one or more other systems or devices, including one or more of the devices of FIG. 2. Additionally, 1700, 1800, and 1900 can include one or more fewer, additional, differently ordered and/or arranged operations than those shown in FIGS. 17-19. In some implementations, some or all of the operations of 1700, 1800, and 1900 can be performed independently, successively, simultaneously, etc., of one or more of the other operations of 1700, 1800, and 1900. As such, the techniques described herein are not limited to the number, sequence, arrangement, timing, etc., of the operations or processes depicted in FIGS. 17-19.

As shown, process 1700 can include stage 1 subnetwork creation (at 1710). As described above, this can involve MN 310 communicating with local UEs 210 to create a subnetwork. This can also include an exchange of parameters between MN 310, UE 210-1, and UE 210-2, including an indication of capabilities of each UE 210 that can enable a determination of which UEs 210 are HC UEs 210 and which are LC UEs 210.

Process 1700 can also include stage 2 subnetwork registration (1720). This can include MN 310 communicating with base station 222 to register the subnetwork with base station 222. While not shown, registering the subnetwork with base station 222 can enable the devices of the subnetwork to engage in decentralized distributed computing that involves one or more other subnetworks. In some implementations, stage 2 can be optional since computation offload is kept within the local subnetwork. In such a scenario, MN 310 can be a private HC node (e.g., a UE 210) configured to offer support to other LC nodes in the subnetwork. Alternatively, MN 310 can be a network or third-party owned HC node configured to support LC nodes in the subnetwork based on a subscription model, for example, which, can be authenticated in stage 1 subnetwork creation (1710) without the involvement of other network or third-party entities (e.g., base station 222, core network 230, application servers 240, compute servers 260, etc.). In such a scenario, computations distribution can be kept within the subnetwork (e.g., within the control of MN 310).

Processes 1700, 1800, and 1900 can include scenarios in which MN 310, UE 210-1 running an OF 410, and UE 210-2 running a CF 420 can each support a CCF 430. This would entail a negotiation between them on who takes control of the compute offload control logic. Process 1700 includes a first example of negotiations between devices about which will operate CCF 430. Process 1800 includes a second example of negotiations between devices about which will operate CCF 430. And process 900 includes alternative outcomes of processes 1700 and 1800.

Process 1700 can include an implementation in which MN 310 determines which devices is to support a managing CCF (at 1720). MN 310 can make this determination based on capability or capacity information received form UE 210-1 and/or UE 210-2 (not shown). The capability or capacity information can be received by MN 310 during stage 1, stage 2 or thereafter. The determination can be based on which device has more available capacity, whether each device has a certain set of capabilities, whether the received capability or capacity information exceeds one or more pre-selected thresholds, and/or one or more other types of criteria.

Process 1700 can also include MN 310 sending a message to UE. 210-1 and UE 210-2, indicating which device is to be the managing CCF. A managing CCF can include the main CCF that is used by devices of the subnetwork for offloading compute tasks. In some implementations, MN 310 can re-evaluate which devices should be the managing CCF according to a prompt (e.g., a request from UE 210), schedule (e.g., periodically), and/or specified event (e.g., a device leaving the subnetwork). As shown by alternative 1, based on the indication from MN 310, UE 210-2 can become the managing CCF 430. By contrast, as shown by alternative 2, based on the indication from MN 310, UE 210-1 can become the managing CCF 430.

Process 1800 can include stage 1 and stage 2 (1810 and 1820) procedures similar to those explained above with reference to FIG. 17. In contrast to process 1700, MN 310 of process 1800 can have no central role determining which devices supports a CCF 430. Instead, the negotiation process is limited to other devices, such as UE 210-1 and UE 210-2. As shown, UEs 210 can broadcast compute capabilities/requests along with their CCF IDs to other UEs 210 in the subnetwork (at 1830). Each broadcast can include a CCF status update with one or more type of information relevant to evaluating whether the sending device should be designated as providing the CCF for the subnetwork. Examples of such information can include a CCF ID, a battery life of UE 210, a compute capacity of UE, a reception (Rx) signal strength, etc.).

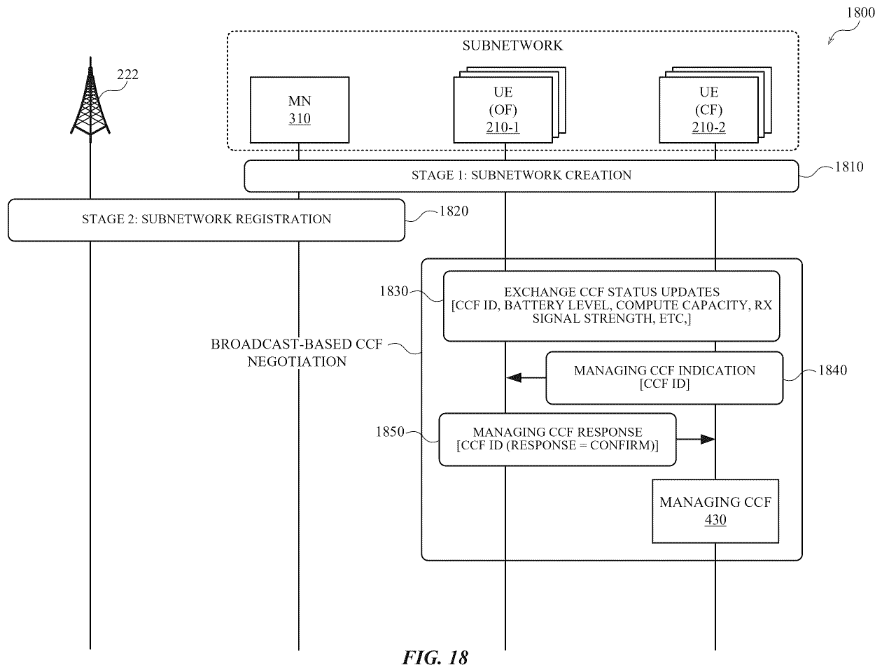

Each UE 210 can receive and evaluate the broadcasted information from other devices (not shown). The evaluation can include applying one or more types of rules, thresholds, criteria, and/or one or more other types of evaluation techniques to the information received. Based on the evaluation, each UE 210 can determine which UE 210 is to operate as the CCF for the subnetwork. For purposes of explaining FIG. 18, assume that UE 210-2 is more qualified to support the CCF than UE 210-1. As such, UE 210-2 can send a managing CCF indication, along with a CCF ID to UE 210-1 (at 1840) and in response, UE 210-1 can send (e.g., via unicast or broadcast) a managing CCF response message that includes the CCF ID of UE 210-2 and a confirmation indication. As such, UE 210-2 can operate as a managing CCF 430 for the subnetwork. In some implementations, UE 210-1 can end up operating as a managing CCF 430 for the subnetwork.

Process 1900 can include stage 1 and stage 2 (1910 and 1920) procedures similar to those explained above with reference to FIGS. 17 and 18. Similar to process 1800, MN 310 of process 1900 can have no central role determining which devices supports a CCF 430 for the subnetwork. In contrast to process 1800, however, process 1900 can involve a request based CCF negotiation, where the CCF device can be determined based on request messages between UEs 210 instead of broadcasted messages.

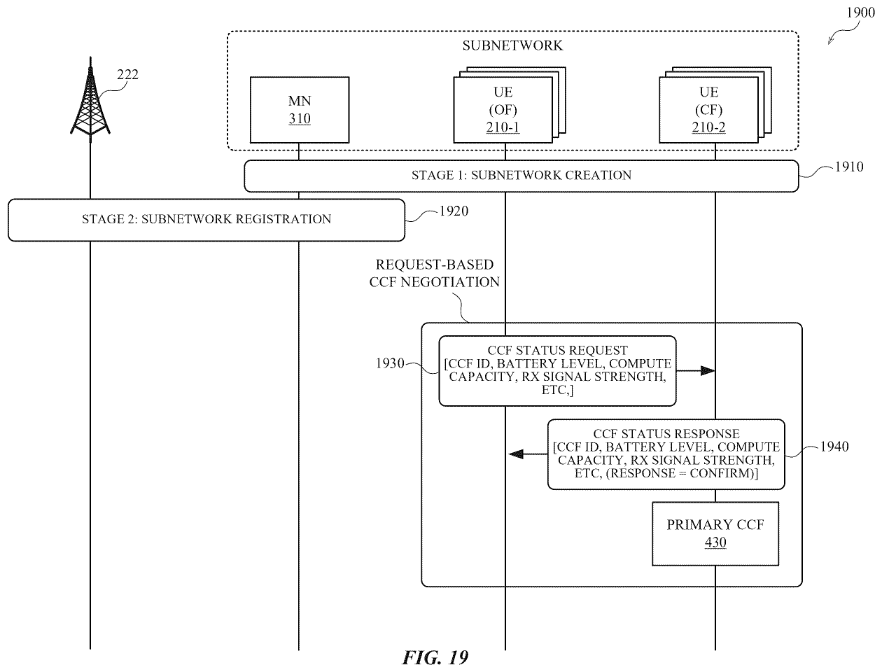

As shown, UE 210-1 can send a CCF status request to UE 210-2 (at 1930). The request can include one or more types of information relevant to sending a request to UE 210-2 about a CCF status or capability of UE 210-2. Examples of such information can include information relating to the sending UE 210-1, such as a CF ID, a battery level compute capacity requirements, a memory requirement, a latency requirement, etc. UE 210-2 can receive the message and evaluate the information from UE 210-1. The evaluation can include applying one or more types of rules, thresholds, criteria, and/or one or more other types of evaluation techniques to the information received. In some implementations, the evaluation can also, or alternatively, include a comparison of capability information of UE 210-2 to the information received from UE 210-1. Based on the evaluation, UE 210-2 can determine whether UE 210-2 is capable to operate as the CCF for UE 210-1 in particular or for the subnetwork. For purposes of explaining FIG. 19, decentralized distributed computing assume that UE 210-2 is qualified to operate a CCF. As such, UE 210-2 can send a CCF status response message to UE 210-1 with one or more types of information. Examples of such information can include information relating to the sending UE 210, such as a CCF ID, a battery level compute capacity requirements, a memory requirement, a latency requirement, etc. UE 210-1 can receive the message and evaluate the information from UE 210-2. As such, UE 210-2 can operate as a managing CCF 430 for the subnetwork. In some implementations, UE 210-1 can end up operating as a managing CCF 430 for the subnetwork.

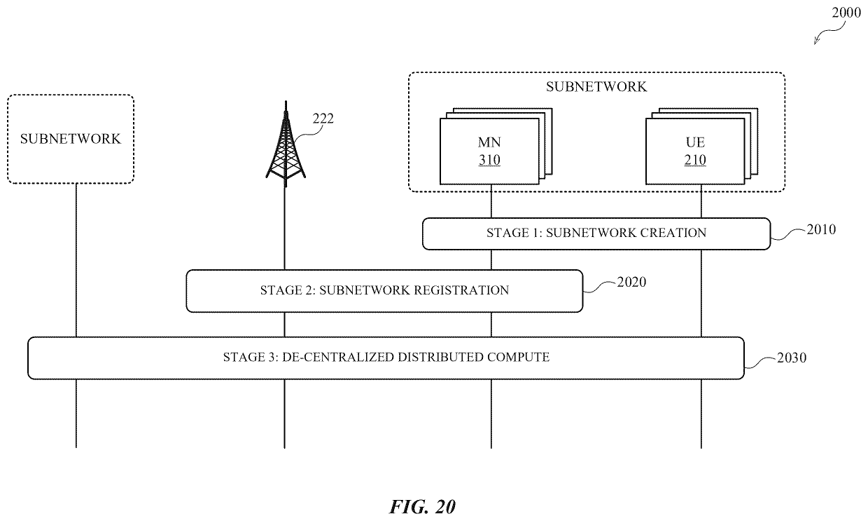

FIG. 20 is a diagram of an example 2000 of decentralized distributed computing between subnetworks according to one or more implementations described herein. As shown, example 2000 can include subnetworks, UEs 210, base station 222, and MN 310. MN 310 can include a UE 210 or another type of wireless device. In stage 1, MN 310 can communicate with local UEs 210 to create a subnetwork. Thus, the subnetwork can include multiple local nodes, such as a smartphone, laptop computer, wearable device (e.g., a wireless necklace, watch, etc.), and/or one or more other types of UEs 210. MN 310 can generate and communicate control plane and user plane information to create the subnetwork and enable decentralized distributed computing within the subnetwork. MN 310 can use a variety of frequency ranges to communicate with other UE 210, including high-frequency spectrum bands (e.g., frequencies of the terahertz (THz) band (e.g., frequencies between 0.3 to 3.0 THz)).

In stage 2, MN 310 can communicate with base station 222 to register the subnetwork with base station 222. Creating the subnetwork can enable decentralized distributed computing among the UEs 210 of the subnetwork and registering the subnetwork with base station 222 can enable decentralized distributed computing, in stage 3, between UEs 210 of different subnetworks, which can include similar types of devices (e.g., MN 310 and UEs 210) and that can also be registered with base station 222. In some implementations, UEs 210 of different subnetwork can engage in decentralized distributed computing directly (e.g., without base station 222 functioning as an information relay or intermediary). In other implementations, UEs 210 and MNs 310 of different subnetworks can engage in decentralized distributed computing among them relying on direct MN 310 to MN 310 communication (e.g., without base station 222 functioning as an information relay or intermediary). Details and examples of these features are discussed in greater detail below with reference to the Figures that follow.

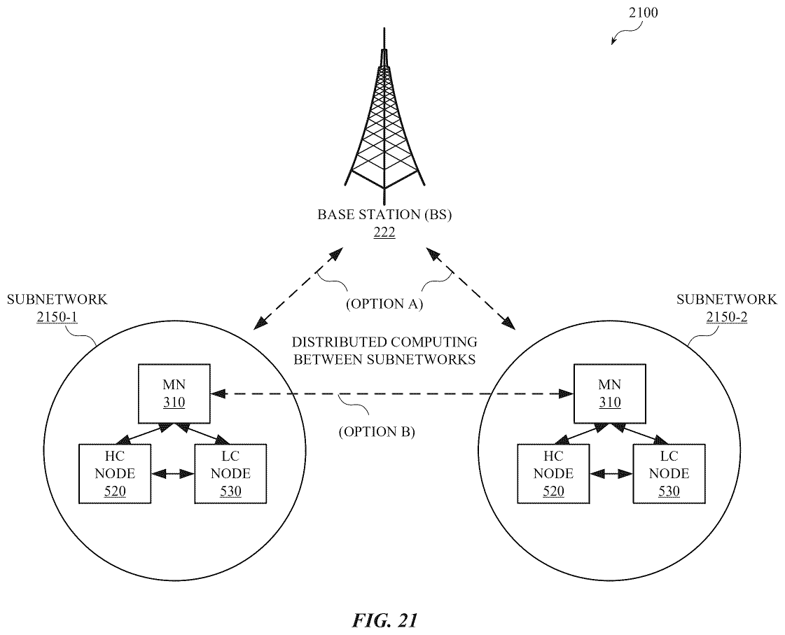

FIG. 21 is a diagram of an example 2100 of nodes of subnetworks for decentralized distributed computing according to one or more implementations described herein. As shown, subnetwork (SUB NW) 2150-1 and sub network (SUB NW) 2150-2 can each include MN 310, HC node 520, and LC node 530. Each node can be implemented as one or more UEs 210, each node can support or perform one or more functions 410-440 and communicate with one another to enable decentralized distributed computing as described herein. In some implementations, decentralized distributed computing can occur between subnetworks 2150-1 and 2150-2 via connections between MNs 2150 and base station 222 (option A). Additionally, or alternatively, decentralized distributed computing can occur between direct connection between MNs 2150 (option B).

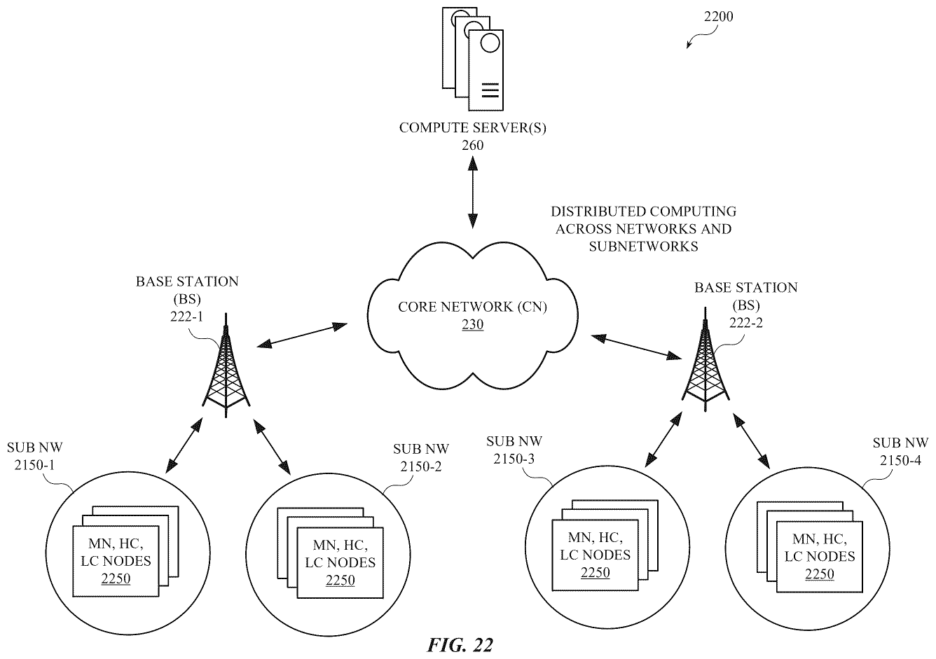

FIG. 22 is a diagram of an example 2200 of decentralized distributed computing involving a network server according to one or more implementations described herein. As shown, subnetworks 2150-1, 2150-2, 2150-3, and 2150-4 can each include MN, HC, and LC nodes 2250. Each node can be implemented as one or more UEs 210, each node can support or perform one or more functions 410-440 and communicate with one another to enable decentralized distributed computing as described herein. Each subnetwork 2150 can be connected to a base station 222-1 or 222-1, which can in turn be connected to core network 230 and one or more compute servers 260. This arrangement of networks and devices can enable different types of decentralized distributed computing, details and examples of which, are described below with reference to the Figs. that follow.

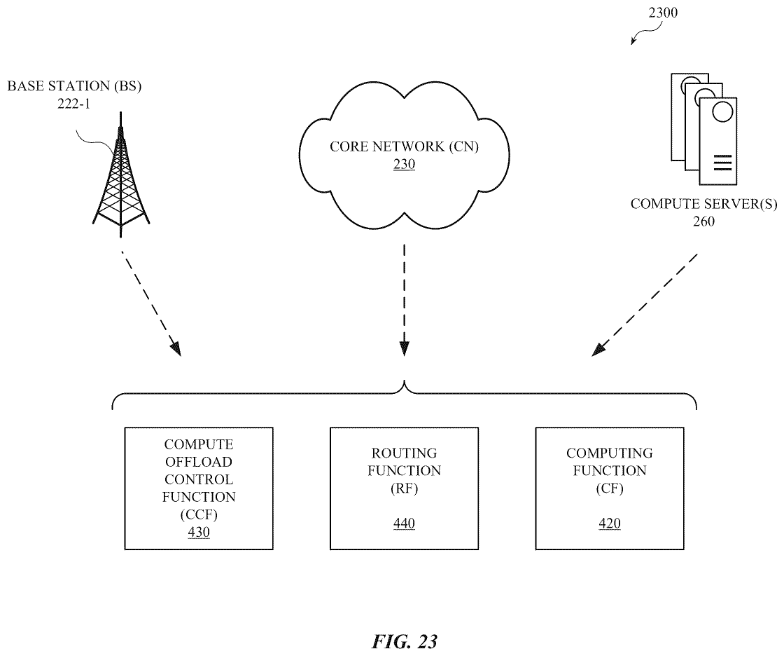

FIG. 23 is a diagram of an example 2300 of network nodes for decentralized distributed computing according to one or more implementations described herein. As shown, example 2300 includes base station 222, CN 230, and one or more computer servers 250. As described herein, similar to how different UEs 210 within a subnetwork can perform different arrangements of functions, implementations described herein include scenarios in which one or more of network entities (e.g., base station 222, CN 230, and one or more computer servers 250) can perform or support one or more functions (e.g., CF 420, CCF 430, RF 440, etc.) to enable decentralized distributed computing.

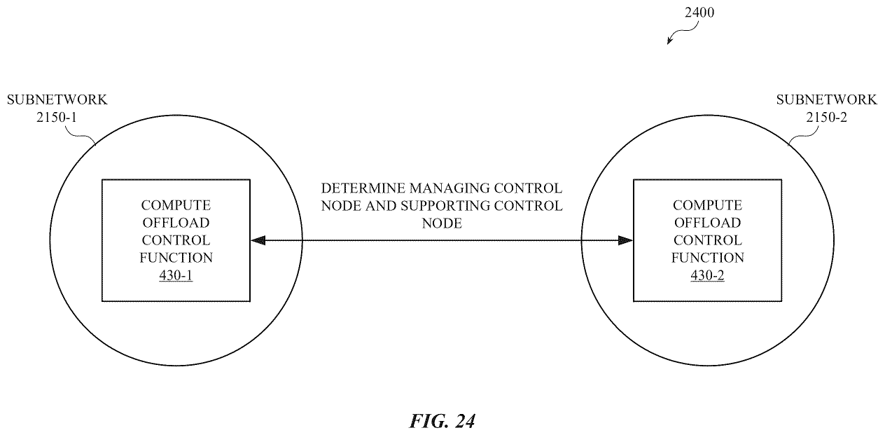

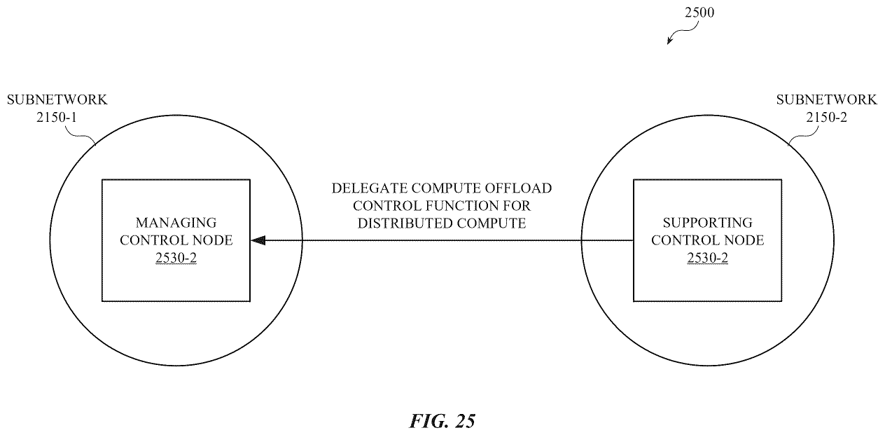

FIGS. 24-25 are diagrams of examples 2400 and 2500 of negotiating compute offload control functions according to one or more implementations described herein. Referring to FIG. 24, CCFs 430 of different subnetworks can engage in, or be the subject of, a negotiation between subnetworks regarding which CCF 430 can operate as a managing CCF 430-1 and which can operate as a supporting CCF. Referring to FIG. 25, a managing CCF 430-1 can have managing CCF 430-1 control of the overall distribution logic involved in decentralized distributed computing, in addition to the handling the management of resource and process management functions of supporting CCFs 430. A supporting CCF can delegate (e.g., to the managing CCF 430-1) some or all of the compute distribution logic as well as the management of resource and process management functions. In some implementations, deployment of either within a network device (e.g., base station, CN, server, etc.) or a subnetwork device (e.g., UE 210) can be anywhere and the negotiation between the different CCFs for determining which is to operate as a managing CCF and which is to operate as a supporting CCF is described in greater detail with reference to the Figures that follow.

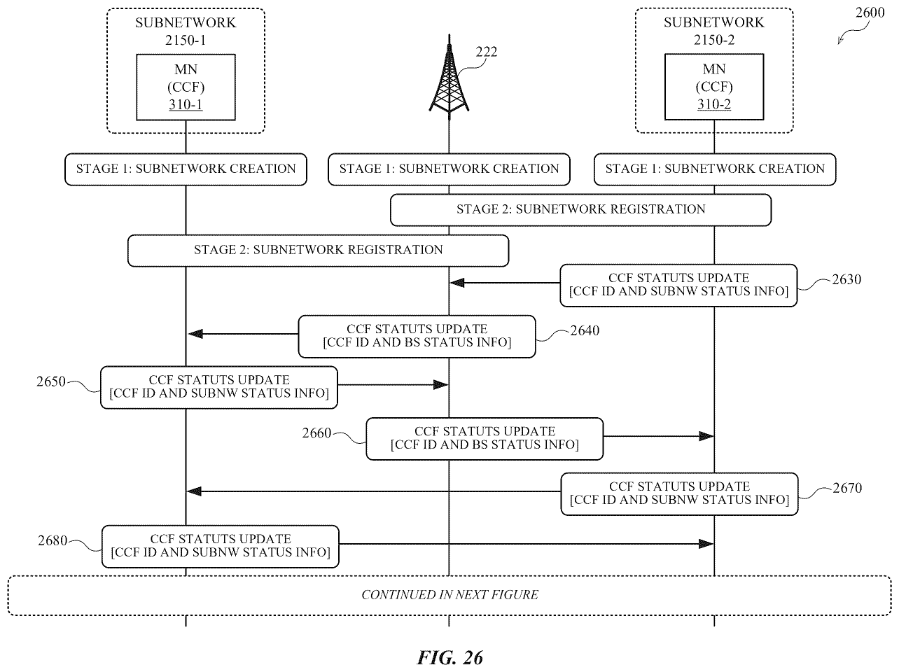

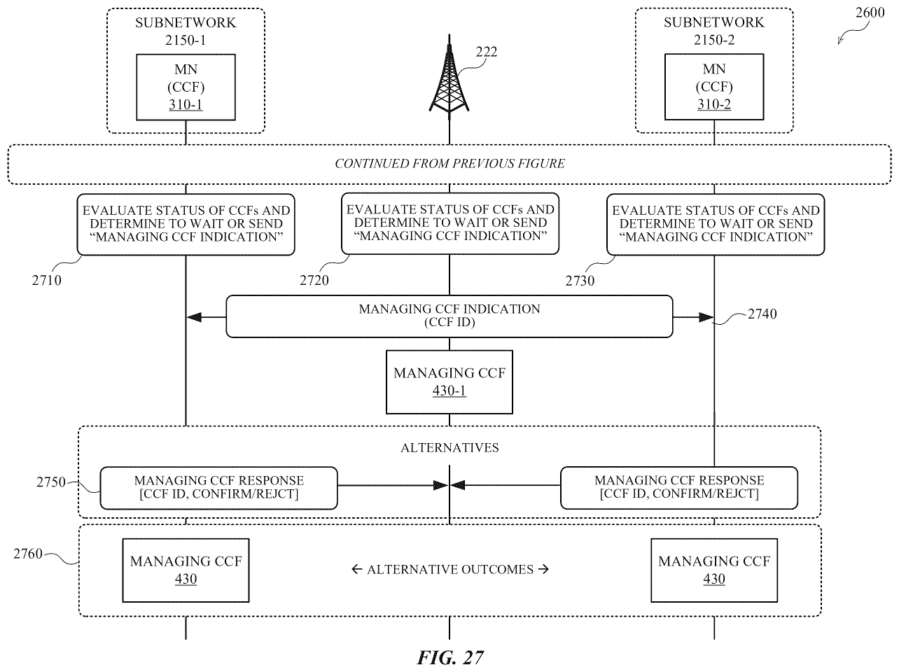

FIGS. 26-27 are diagrams of an example of a process 2600 for decentralized distributed computing between subnetworks according to one or more implementations described herein. Process 2600 can be implemented by base station 222, MNs 310-1 and 310-2 of subnetworks 2150-1 and 2150-2. As shown, MNs 310-1 and 310-2 can include CCFs. In some implementations, some or all of process 2600 can be performed by one or more other systems or devices, including one or more of the devices of FIG. 2. Additionally, process 2600 can include one or more fewer, additional, differently ordered and/or arranged operations than those shown in FIGS. 26-27. In some implementations, some or all of the operations of process 2600 can be performed independently, successively, simultaneously, etc., of one or more of the other operations of process 2600. As such, the techniques described herein are not limited to the number, sequence, arrangement, timing, etc., of the operations or processes depicted in FIGS. 26-27.

As shown, example 2600 can include subnetworks 2150-1, MN 310-1, base station 222, subnetwork 2150-2, and MN 310-2. Subnetworks 2150-1 and 2150-2 can include more devices and nodes as shown in FIG. 26. In stage 1, MN 310-1 and 310-2 can communicate with local UEs 210 (not shown) to create subnetworks 2150-1 and 2150-2. Thus, subnetworks 2150-1 and 2150-2 can include multiple local nodes, such as a smartphone, laptop computer, wearable device (e.g., a wireless necklace, watch, etc.), and/or one or more other types of UEs 210. MN 310-1 and 310-2 can generate and communicate control plane and user plane information to create the subnetwork and enable decentralized distributed computing within subnetwork 2150-1 and 2150-2. MN 310-1 and 310-2 can use a variety of frequency ranges to communicate with other UE 210, including high-frequency spectrum bands (e.g., frequencies of the terahertz (THz) band (e.g., frequencies between 0.3 to 3.0 THz)). In some implementations, base station 222 can instead by another subnetwork similar to subnetworks 2150-1 and 2150-2, and can undergo stage 2 subnetwork creation in a similar manner.

In stage 2, MN 310-1 and 310-2 can communicate with base station 222 to register subnetworks 2150-1 and 2150-2 with base station 222. Creating subnetwork 2150-1 and 2150-2 can enable decentralized distributed computing among the UEs 210 of subnetwork 2150-1 and 2150-2 and reregistering the subnetwork with base station 222 can enable decentralized distributed computing, in stage 3, between UEs 210 of different subnetworks 2150-1 and 2150-2 via base station 222. In some implementations, UEs 210 of different subnetworks 2150-1 and 2150-2 can engage in decentralized distributed computing directly (e.g., without base station 222 functioning as an information relay or intermediary).

Stage 2 can be either a mandatory or optional step depending on the scenario or implementation. For example, when compute resources of another subnetwork are to be accessed via base station 222 step 2 can be mandatory. Though a CCF of base station 222 may not be triggered, the communications of base station 222 can be utilized such that the subnetworks 2150-1 and 2150-2 can be registered via stage 2. When compute resources of another subnetwork are to be accessed via direct MN-to-MN communication, stage 2 can be optional since the MNs 310-1 and 310-2 of subnetworks 2150-1 and 2150-2 can communicate without using base station 222. Details and examples of these features are discussed in greater detail below with reference to the Figures that follow.

Process 2600 can include an example of CCFs negotiations to enable decentralized distributed computing between different subnetworks 2150-1 and 2150-2. This can be common for some or all decentralized compute offload scenarios, where the different available CCF entities negotiate between each other to decide which of the involved CCFs would take the role of the managing CCF with the remaining acting as supporting CCFs.

MN 310-2 can send a CCF status update to base station 222 (at 2630). The CCF status update can include a CCF ID of the CCF of MN 310-2. The CCF status update can also, or alternatively include a battery level, a subnetwork compute request, a Rx signal strength, etc., regarding MN 310-2 and/or subnetwork 2150-2. Base station 222 can send a CCF status update to MN 310-1 (at 2640). The CCF status update can include a CCF ID of a CCF (not shown) of base station 222. The CCF status update can also, or alternatively include a battery level, a base station compute capacity, a base station compute request, an RX signal strength, etc., regarding base station 222. MN 310-1 can send a CCF status update to base station 222 (at 2650). The CCF status update can include a CCF ID of the CCF of MN 310-1. The CCF status update can also, or alternatively include a battery level of MN 310-1, a base station compute capacity, a base station compute request, an RX signal strength, etc., regarding MN 310-1 and/or subnetwork 2150-1

Base station 222 can send a CCF status update to MN 310-2 (at 2660). The CCF status update can include a CCF ID of a CCF (not shown) of base station 222. The CCF status update can also, or alternatively include a battery level, a base station compute capacity, a base station compute request, an RX signal strength, etc., regarding base station 222. MN 310-2 can send a CCF status update to MN 310-1 (at 2670). The CCF status update can include a CCF ID of the CCF of MN 310-2. The CCF status update can also, or alternatively include a battery level of MN 310-2, a subnetwork compute capacity, a subnetwork compute request, an RX signal strength, etc., regarding MN 310-2 and/or subnetwork 2150-2.

MN 310-1 can send a CCF status update to MN 310-2 (at 2680). The CCF status update can include a CCF ID of the CCF of MN 310-1. The CCF status update can also, or alternatively include a battery level of MN 310-1, a subnetwork compute capacity, a subnetwork compute request, an RX signal strength, etc., regarding MN 310-1 and/or subnetwork 2150-1. As such, subnetworks 2150-1 and 2150-2 can each be aware of a status, availability, capacity etc., of MN 310-1, MN 310-2, and/or base station 222. In some implementations, one or more of operations 2630-2680 can occur in a different arrangement or order of operations.

One or more of the CCF status update described above can be transmitted periodically, in response to an event-trigger using broadcast, multicast or unicast communication (e.g., via SIBs or dedicated signaling).

Referring to FIG. 27 process 2600, base station 222 and MNs 310-1 and 310-2 can evaluate the information received from one another to determine (e.g., to negotiate) which device is to operate as a managing CCF (at 2710, 2720, and 2730). Based on the evaluation, base station 222 and MNs 310-1 and 310-2 can wait to receive or send a managing CCF indicator to one another. The determination can be standardized or kept up to each manufacturer's own decision metrics. Each entity receives a managing CCF indicator can determine whether to reject or confirm the managing CCF indicator. This can include each entity (e.g., MN 310, base station 222, etc.) comparing information in the managing CCF indicator to similar information of the receiving entity to determine whether the receiving entity is better suited to operate as a managing CCF. When multiple managing CCF indicators are received by an entity the entity can compare the information from each of the managing CCF indicators, and with similar information of the receiving entity determine which entity is best suited to be the managing CCF. In response to this evaluation, each entity can store the CCF ID of its managing CCF or CCF ID of any of its supporting CCFs (i.e., when acting as a managing CCF). The managing CCF can store the CCF IDs of all CCFs (i.e., supporting CCFs) that have indicated that the managing CCF is configured to be their managing CCF.

In some implementations, base station 222 can determine that base station 222 is to be the managing CCF and can communicate a managing CCF indication message to MNs 310-1 and 310-2 (at 2740). The managing CCF indication message can include a CCF ID associated with the CCF of base station 222 in this implementation. Doing so can inform MNs 310-1 and 310-2 that the CCF of base station 222 is the managing CCF 430-1 for decentralized distributed computing between subnetworks 2150-1 and 2150-2. In some implementations, MNs 310-1 and 310-2 can respond to the managing CCF indication message from base station 222 by sending a managing CCF response message (at 2750). The managing CCF response messages can include an indication of a CCF ID and an indication of whether the CCF of the CCF ID is accepted or rejected as the managing CCF for decentralized distributed computing between subnetworks 2150-1 and 2150-2. As shown, an outcome of these managing CCF response messages can include MN 310-1 or MN 310-2 becoming the managing CCF 430-1 (e.g., instead of the CCF of base station 222 becoming the managing CCF 430-1 (at 2760).

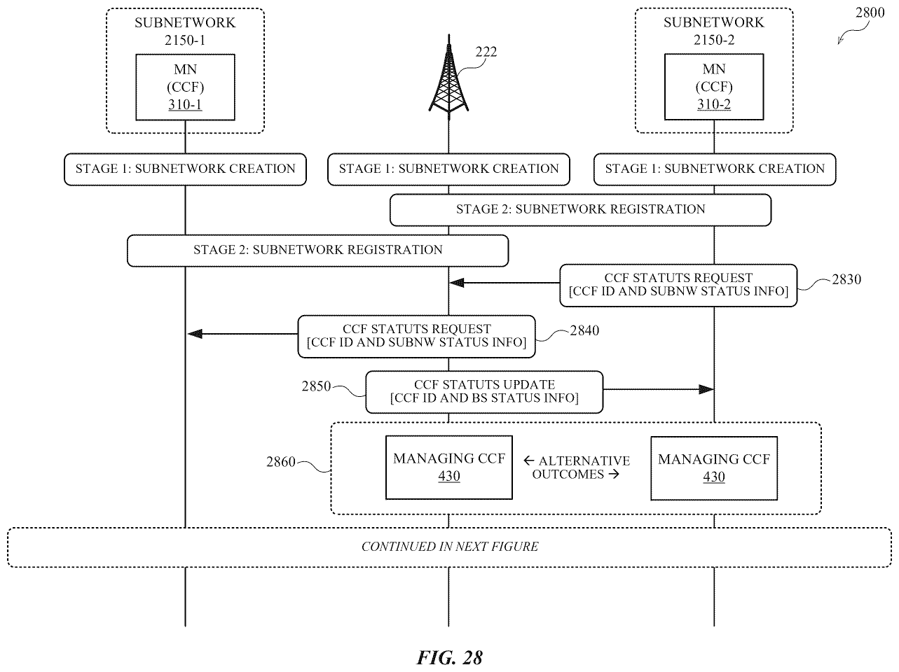

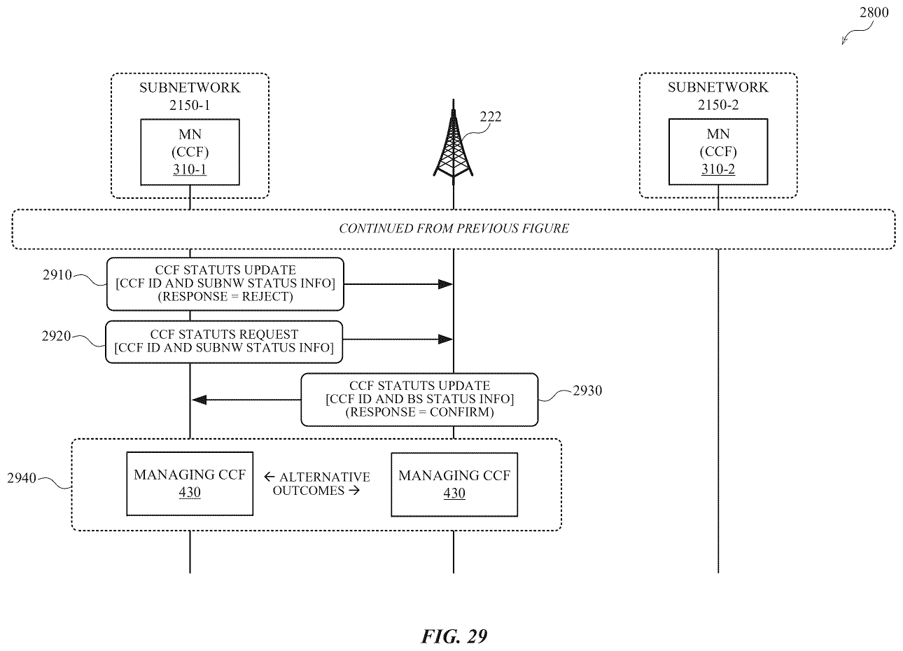

FIGS. 28-29 are diagrams of an example of a process 2800 for decentralized distributed computing between subnetworks according to one or more implementations described herein. Process 2800 can be implemented by base station 222, MNs 310-1 and 310-2 of subnetworks 2150-1 and 2150-2. As shown, MNs 310-1 and 310-2 can include CCFs. In some implementations, some or all of process 2800 can be performed by one or more other systems or devices, including one or more of the devices of FIG. 2. Additionally, process 2800 can include one or more fewer, additional, differently ordered and/or arranged operations than those shown in FIGS. 28-29. In some implementations, some or all of the operations of process 2800 can be performed independently, successively, simultaneously, etc., of one or more of the other operations of process 2800. As such, the techniques described herein are not limited to the number, sequence, arrangement, timing, etc., of the operations or processes depicted in FIGS. 28-29.

As shown, example 2800 can include subnetworks 2150-1, MN 310-1, base station 222, subnetwork 2150-2, and MN 310-2. Subnetworks 2150-1 and 2150-2 can include more devices and nodes as shown in FIG. 28. In stage 1, MN 310-1 and 310-2 can communicate with local UEs 210 (not shown) to create subnetworks 2150-1 and 2150-2. Thus, subnetworks 2150-1 and 2150-2 can include multiple local nodes, such as a smartphone, laptop computer, wearable device (e.g., a wireless necklace, watch, etc.), and/or one or more other types of UEs 210. MN 310-1 and 310-2 can generate and communicate control plane and user plane information to create the subnetwork and enable decentralized distributed computing within subnetwork 2150-1 and 2150-2. MN 310-1 and 310-2 can use a variety of frequency ranges to communicate with other UE 210, including high-frequency spectrum bands (e.g., frequencies of the terahertz (THz) band (e.g., frequencies between 0.3 to 3.0 THz)). In some implementations, base station 222 can instead by another subnetwork similar to subnetworks 2150-1 and 2150-2, and can undergo stage 2 subnetwork creation in a similar manner.

In stage 2, MN 310-1 and 310-2s can communicate with base station 222 to register subnetworks 2150-1 and 2150-2 with base station 222. Creating subnetwork 2150-1 and 2150-2 can enable decentralized distributed computing among the UEs 210 of subnetwork 2150-1 and 2150-2 and reregistering the subnetwork with base station 222 can enable decentralized distributed computing, in stage 3, between UEs 210 of different subnetworks 2150-1 and 2150-2 via base station 222. In some implementations, UEs 210 of different subnetworks 2150-1 and 2150-2 can engage in decentralized distributed computing directly (e.g., without base station 222 functioning as an information relay or intermediary).

Stage 2 can be either a mandatory or optional step depending on the scenario or implementation. For example, when compute resources of another subnetwork are to be accessed via base station 222 step 2 can be mandatory. Though a CCF of base station 222 may not be triggered, the communications of base station 222 can be utilized such that the subnetworks 2150-1 and 2150-2 and 2150-2 can be registered via step 2. When compute resources of another subnetwork are to be accessed via directed MN-to-MN communication, stage 2 can be optional since the MNs 310-1 and 310-2 of subnetworks 2150-1 and 2150-2 can communicate without using base station 222.

Process 2800 can include an approach for CCF negotiation, where instead of being periodic or event-triggered, the CCF status update can be sent as a response to an explicit request (e.g., a CCF status request).

Process 2800 can include an example of CCFs negotiations to enable decentralized distributed computing between different subnetworks 2150-1 and 2150-2. This can be common for some or all decentralized compute offload scenarios where the different available CCF entities negotiate between each other to decide which of the involved CCFs would take the role of the managing CCF with the remaining acting as supporting CCFs. MN 310-2 can send a CCF status request to base station 222 (at 2830). The CCF status request can include a CCF ID of the CCF of MN 310-2. The CCF status update can also, or alternatively, include a battery level, a subnetwork compute request, a Rx signal strength, etc. The request can proxy as a request for the targeted CCF of base station 222 to operate as a managing CCF for MN 310-2. Base station 222 can send a CCF status request to MN 310-1 (at 2840). The CCF status request can include a CCF ID of the CCF of base station 222. The CCF status update can also, or alternatively, include a battery level, a subnetwork compute request, a Rx signal strength, etc. The request can proxy as a request for the targeted CCF of MN 310-1 to operate as a managing CCF for base station 222.

Base station 222 can send a CCF status update to MN 310-1 (at 2850). The CCF status update can include a CCF ID of a CCF (not shown) of base station 222. The CCF status update can also, or alternatively include a battery level, a base station compute capacity, a base station compute request, an Rx signal strength, etc. The CCF status update can include a confirmation that base station 222 can operate as a managing CCF with a supporting CCF of CCF ID of subnetwork 2150-2. As such, base station 222 can operate as a managing CCF with a supporting CCF of CCF ID of subnetwork 2150-2, and MN 310-2 can register a managing CCF with a CCF ID of the CCF of base station 222.

Referring to FIG. 29, process 2800 can include MN 310-1 sending a CCF status update to base station 222 (at 2910). The CCF status update can include a CCF ID of the CCF of MN 310-1. The CCF status update can also, or alternatively include a battery level of MN 310-1, a subnetwork compute capacity, a subnetwork compute request, an Rx signal strength, etc., regarding MN 310-1 and/or subnetwork 2150-1. The CCF status update can also include a rejection response regarding base station 222 operating as a managing CCF to MN 310-1 and/or subnetwork 2150-1.

MN 310-1 can send a CCF status request to base station (at 2920). The CCF status request can include a CCF ID of the CCF of MN 310-1. The CCF status update can also, or alternatively include a battery level of MN 310-1, a subnetwork compute capacity, a subnetwork compute request, an Rx signal strength, etc. Base station 222 can respond by sending MN 310-2 a CCF status update (at 2930). The CCF status update can include a CCF ID of the CCF of base station 222. The CCF status update can also, or alternatively include a battery level of base station 222, a compute capacity, a compute request, an Rx signal strength, etc., regarding base station 222.

The CCF status update can also include a confirm response regarding base station 222 operating as a managing CCF for MN 310-1 and/or subnetwork 2150-1. As such, base station 222 can operate as a managing CCF with a CCF ID of base station 222, and base station 222 can operate as a managing CCF with supporting CCFs of subnetworks 2150-1 and 215-2. As such, the example of FIGS. 28-29 can include a request-based approach for CCF negotiation, where instead of being periodic or event-triggered the CCF status update gets sent as a response to an explicit request, specifically CCF status request. When Response=Confirm, then the responding CCF can act as a managing CCF of the requesting CCF. When Response=Reject, the requesting CCF can have to request from another CCF via sending another CCF status request message.

Generally, a CCF status request message can indicate a node's compute capacity, requests, and Rx signal strength among other parameters. The request can also proxy as a request for a targeted CCF to act as a managing CCF. In response to the request, the node can respond with a CCF status update message that can include a compute capacity, requests, and Rx signal strength, among other parameters, and can also include a response message either confirming or rejecting the request. When the response=confirm, then the responding CCF can then operate as a managing CCF of the requesting CCF. When the response=reject, then the requesting CCF would request, from another CCF, via sending another CCF status request message (e.g., a highlighted with a messaging exchange of subnetwork 2150-1 in MSC). For example, when the response=reject, the requesting CCF can request, from another CCF, via sending another CCF status request message. In FIG. 29, MN 310-1 can send a CCF status update message to base station 222 with response=reject (at 2910), and MN 310-1 can also send a CCF status request message to base station 222 (at 2920) and can await a CCF status update message 2930 from base station 222 in response. This procedure can be followed by all MNs 310, UEs 210, and base station 222 in order to decide on a managing CCF and a supporting CCF roles. In some scenarios, this negotiation option can be viable regardless of whether direct physical connection is possible between subnetworks. However, for non-physical connections there can be a consensus between devices regarding certain aspects of the communication (e.g., IP addresses, Application, etc.) to be established to allow for such non-physical direct communication.

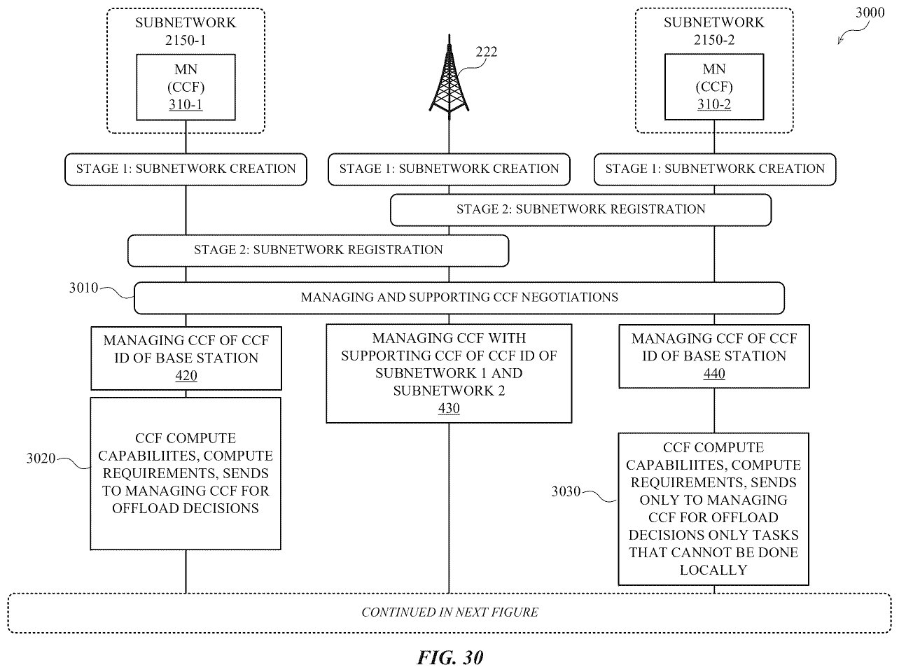

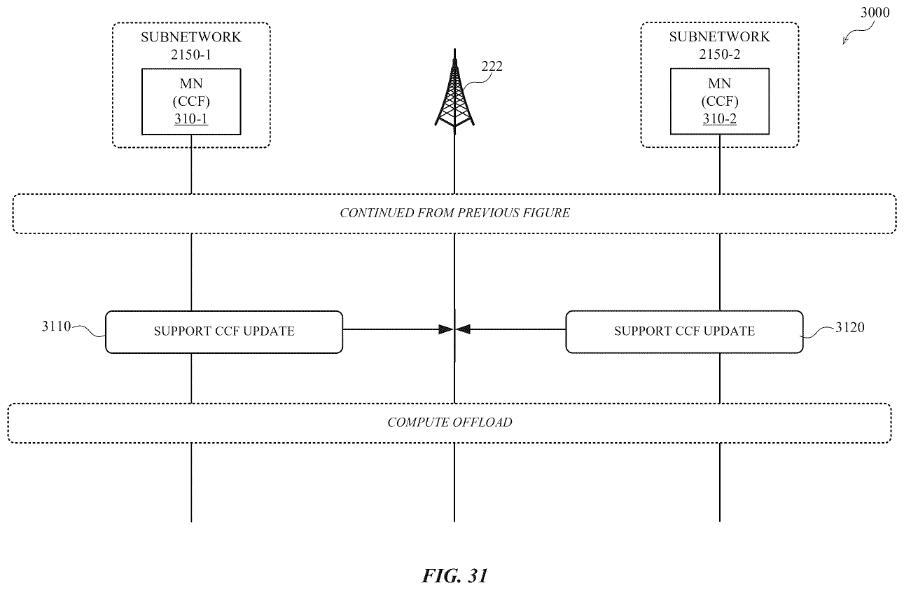

FIGS. 30-31 are diagrams of an example of a process 3000 for decentralized distributed computing between subnetworks according to one or more implementations described herein. As shown, process 3000 can include subnetworks 2150-1, MN 310-1, base station 222, subnetwork 2150-2, and MN 310-2. Subnetworks 2150-1 and 2150-2 can include more devices and nodes as shown in FIG. 30. In stage 1, MN 310-1 and 310-2 can communicate with local UEs 210 (not shown) to create subnetworks 2150-1 and 2150-2. Thus, subnetworks 2150-1 and 2150-2 can include multiple local nodes, such as a smartphone, laptop computer, wearable device (e.g., a wireless necklace, watch, etc.), and/or one or more other types of UEs 210. MN 310-1 and 310-2 can generate and communicate control plane and user plane information to create the subnetwork and enable decentralized distributed computing within subnetwork 2150-1 and 2150-2. MN 310-1 and 310-2 can use a variety of frequency ranges to communicate with other UE 210, including high-frequency spectrum bands (e.g., frequencies of the terahertz (THz) band (e.g., frequencies between 0.3 to 3.0 THz)).

In stage 2, MN 310-1 and 310-2s can communicate with base station 222 to register subnetworks 2150-1 and 2150-2 with base station 222. Creating subnetwork 2150-1 and 2150-2 can enable decentralized distributed computing among the UEs 210 of subnetwork 2150-1 and 2150-2 and reregistering the subnetwork with base station 222 can enable decentralized distributed computing, in stage 3, between UEs 210 of different subnetworks 2150-1 and 2150-2 via base station 222. In some implementations, UEs 210 of different subnetworks 2150-1 and 2150-2 can engage in decentralized distributed computing directly (e.g., without base station 222 functioning as an information relay or intermediary).

Stage 2 can be either a mandatory or optional step depending on the scenario or implementation. For example, when compute resources of another subnetwork are to be accessed via base station 222 step 2 can be mandatory. Though a CCF of base station 222 may not be triggered, the communications of base station 222 can be utilized such that the subnetworks 2150-1 and 2150-2 and 2150-2 can be registered via step 2. When compute resources of another subnetwork are to be accessed via directed MN-to-MN communication, stage 2 can be optional since the MNs 310-1 and 310-2 of subnetworks 2150-1 and 2150-2 can communicate without using base station 222.

Example 3000 can include an example of supporting CCF being either non-transparent (e.g., MN 310-2) or a transparent mode. (e.g., MN 310-1). As shown, a CCF in transparent mode (e.g., MN 310-1) may not evaluate the required compute tasks and available compute resources within the local subnetwork regardless of whether some compute tasks can be performed locally (at 3020). A CCF in non-transparent mode (e.g., MN 310-2) can evaluate the required compute tasks and available compute resources within the local subnetwork and decides which tasks can be locally offloaded (at 3030). The CCF in transparent mode (e.g., MN 310-1) can send out a request for all subnetwork compute tasks and compute capabilities to the managing CCN (e.g., base station 222) (at 3110 of FIG. 31). By contrast, a CCF in non-transparent mode (e.g., MN 310-2) can send out a request for the surplus subnetwork compute tasks or capabilities (i.e., after aggregating all local subnetwork 2150-2 compute tasks and capabilities and computing the surplus or shortage) to the managing CCF (e.g., base station 222) that may not be handled by the local subnetwork (at 3110 of FIG. 31). The managing CCF (e.g., base station 222) can in turn can take full control on the distribution of the compute offload procedures among all the available compute resources (e.g., full managing CCF control).

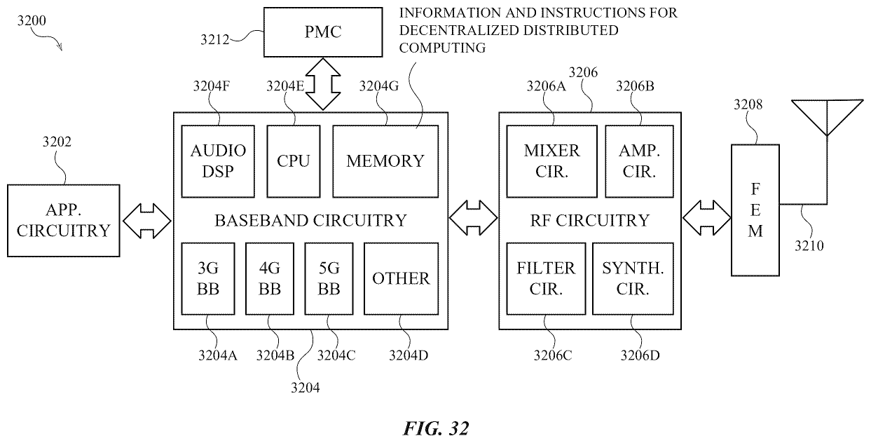

FIG. 32 is a diagram of an example of components of a device according to one or more implementations described herein. In some implementations, device 3200 can include application circuitry 3202, baseband circuitry 3204, RF circuitry 3206, front-end module (FEM) circuitry 3208, one or more antennas 3210, and power management circuitry (PMC) 3212 coupled together at least as shown. In some implementations, device 3200 can include fewer elements (e.g., a RAN node may not utilize application circuitry 3202 and can instead include a processor/controller to process data received from a core network. In some implementations, device 3200 can include additional elements such as, for example, memory/storage, display, camera, sensor (including one or more temperature sensors, such as a single temperature sensor, a plurality of temperature sensors at different locations in device 3200, etc.), or input/output (I/O) interface. In other implementations, the components described below can be included in more than one device (e.g., said circuitries can be separately included in more than one device for cloud-RAN (C-RAN) implementations).

Application circuitry 3202 can include one or more application processors. For example, application circuitry 3202 can include circuitry such as, but not limited to, one or more single-core or multi-core processors. The processor(s) can include any combination of general-purpose processors and dedicated processors (e.g., graphics processors, application processors, etc.). The processors can be coupled with or can include memory/storage and can be configured to execute instructions stored in the memory/storage to enable various applications or operating systems to run on device 3200. In some implementations, processors of application circuitry 3202 can process data packets received from a core network.

Baseband circuitry 3204 can include circuitry such as, but not limited to, one or more single-core or multi-core processors. Baseband circuitry 3204 can include one or more baseband processors or control logic to process baseband signals received from a receive signal path of RF circuitry 3206 and to generate baseband signals for a transmit signal path of RF circuitry 3206. Baseband circuitry 3204 can interface with application circuitry 3202 for generation and processing of the baseband signals and for controlling operations of RF circuitry 3206. For example, in some implementations, baseband circuitry 3204 can include a 3G baseband processor 3204A, a 4G baseband processor 3204B, a 5G baseband processor 3204C, or other baseband processor(s) 3204D for other existing generations, generations in development or to be developed in the future (e.g., 5G, 6G, 7G, etc.). Baseband circuitry 3204 (e.g., one or more of baseband processors 3204A-D) can handle various radio control functions that enable communication with one or more radio networks via RF circuitry 3206. In other implementations, some or all of the functionality of baseband processors 3204A-D can be included in modules stored in memory 3204G and executed via a central processing unit (CPU) 3204E. The radio control functions can include, but are not limited to, signal modulation/demodulation, encoding/decoding, radio frequency shifting, etc. In some implementations, modulation/demodulation circuitry of baseband circuitry 3204 can include Fast-Fourier Transform (FFT), precoding, or constellation mapping/de-mapping functionality. In some implementations, encoding/decoding circuitry of baseband circuitry 3204 can include convolution, tail-biting convolution, turbo, Viterbi, or low-density parity check (LDPC) encoder/decoder functionality. Implementations of modulation/demodulation and encoder/decoder functionality are not limited to these examples and can include other suitable functionality in other implementations.

In some implementations, memory 3204G may receive and/or store information and instructions for decentralized distributed computing within a wireless environment. A set of local wireless devices (e.g., UEs 210) can form a subnetwork with each other. UEs 210 can support various functions to enable compute tasks to be offloaded from come subnetwork devices and performed by other subnetwork devices. The result produced by performing the task can be returned to the device that offloaded the task. MN 310 of the subnetwork can connect to base station 222 and/or directly to an MN 310 of another subnetwork. Computing tasks can be offloaded from the subnetwork, performed by another subnetwork or a network device (such as base station 222 or a network server), and the results of the task performed can be returned to the subnetwork that offloaded the task. These and many other features are techniques are described in detail herein.

In some implementations, baseband circuitry 3204 can include one or more audio digital signal processor(s) (DSP) 3204F. Audio DSP 3204F can include elements for compression/decompression and echo cancellation and can include other suitable processing elements in other implementations. Components of baseband circuitry 3204 can be suitably combined in a single chip, a single chipset, or disposed on a same circuit board in some implementations. In some implementations, some or all of the constituent components of baseband circuitry 3204 and application circuitry 3202 can be implemented together such as, for example, on a system on a chip (SOC).

In some implementations, baseband circuitry 3204 can provide for communication compatible with one or more radio technologies. For example, in some implementations, baseband circuitry 3204 can support communication with a NG-RAN, an evolved universal terrestrial radio access network (EUTRAN) or other wireless metropolitan area networks (WMAN), a wireless local area network (WLAN), a wireless personal area network (WPAN), etc. Implementations in which baseband circuitry 3204 is configured to support radio communications of more than one wireless protocol can be referred to as multi-mode baseband circuitry.

RF circuitry 3206 can enable communication with wireless networks using modulated electromagnetic radiation through a non-solid medium. In various implementations, RF circuitry 3206 can include switches, filters, amplifiers, etc., to facilitate the communication with the wireless network. RF circuitry 3206 can include a receive signal path which can include circuitry to down-convert RF signals received from FEM circuitry 3208 and provide baseband signals to baseband circuitry 3204. RF circuitry 3206 can also include a transmit signal path which can include circuitry to up-convert baseband signals provided by baseband circuitry 3204 and provide RF output signals to FEM circuitry 3208 for transmission.

In some implementations, the receive signal path of RF circuitry 3206 can include mixer circuitry 3206A, amplifier circuitry 3206B and filter circuitry 3206C. In some implementations, the transmit signal path of RF circuitry 3206 can include filter circuitry 3206C and mixer circuitry 3206A. RF circuitry 3206 can also include synthesizer circuitry 3206D for synthesizing a frequency for use by mixer circuitry 3206A of the receive signal path and the transmit signal path. In some implementations, mixer circuitry 3206A of the receive signal path can be configured to down-convert RF signals received from FEM circuitry 3208 based on the synthesized frequency provided by synthesizer circuitry 3206D. Amplifier circuitry 3206B can be configured to amplify the down-converted signals and filter circuitry 3206C can be a low-pass filter (LPF) or band-pass filter (BPF) configured to remove unwanted signals from the down-converted signals to generate output baseband signals. Output baseband signals can be provided to baseband circuitry 3204 for further processing. In some implementations, the output baseband signals can be zero-frequency baseband signals, although this may not be a requirement. In some implementations, mixer circuitry 3206A of the receive signal path can comprise passive mixers, although the scope of the implementations is not limited in this respect.

In some implementations, mixer circuitry 3206A of the transmit signal path can be configured to up-convert input baseband signals based on the synthesized frequency provided by synthesizer circuitry 3206D to generate RF output signals for FEM circuitry 3208. The baseband signals can be provided by baseband circuitry 3204 and can be filtered by filter circuitry 3206C. In some implementations, mixer circuitry 3206A of the receive signal path and mixer circuitry 3206A of the transmit signal path can include two or more mixers and can be arranged for quadrature down conversion and up conversion, respectively. In some implementations, mixer circuitry 3206A of the receive signal path and mixer circuitry 3206A of the transmit signal path can include two or more mixers and can be arranged for image rejection. In some implementations, mixer circuitry 3206A of the receive signal path and mixer circuitry 3206A can be arranged for direct down conversion and direct up conversion, respectively. In some implementations, mixer circuitry 3206 of the receive signal path and mixer circuitry 3206A of the transmit signal path can be configured for super-heterodyne operation.

In some implementations, the output baseband signals, and the input baseband signals can be analog baseband signals, although the scope of the implementations is not limited in this respect. In some alternate implementations, the output baseband signals, and the input baseband signals can be digital baseband signals. In these alternate implementations, RF circuitry 3206 can include analog-to-digital converter (ADC) and digital-to-analog converter (DAC) circuitry and baseband circuitry 3204 can include a digital baseband interface to communicate with RF circuitry 3206.

In some dual-mode implementations, a separate radio integrated circuitry can be provided for processing signals for each spectrum, although the scope of the implementations is not limited in this respect. In some implementations, synthesizer circuitry 3206D can be a fractional-N synthesizer or a fractional N/N+1 synthesizer, although the scope of the implementations is not limited in this respect as other types of frequency synthesizers can be suitable. For example, synthesizer circuitry 3206D can be a delta-sigma synthesizer, a frequency multiplier, or a synthesizer comprising a phase-locked loop with a frequency divider.

Synthesizer circuitry 3206D can be configured to synthesize an output frequency for use by mixer circuitry 3206A of RF circuitry 3206 based on a frequency input and a divider control input. In some implementations, synthesizer circuitry 3206D can be a fractional N/N+1 synthesizer. In some implementations, frequency input can be provided by a voltage-controlled oscillator (VCO). Divider control input can be provided by either baseband circuitry 3204 or the applications circuitry 3202 depending on the desired output frequency. In some implementations, a divider control input (e.g., N) can be determined from a look-up table based on a channel indicated by the applications circuitry 3202.

Synthesizer circuitry 3206D of RF circuitry 3206 can include a divider, a delay-locked loop (DLL), a multiplexer, and a phase accumulator. In some implementations, the divider can be a dual modulus divider (DMD), and the phase accumulator can be a digital phase accumulator (DPA). In some implementations, the DMD can be configured to divide the input signal by either N or N+1 (e.g., based on a carry out) to provide a fractional division ratio. In some example implementations, the DLL can include a set of cascaded, tunable, delay elements, a phase detector, a charge pump and a D-type flip-flop. In these implementations, the delay elements can be configured to break a VCO period up into Nd equal packets of phase, where Nd is the number of delay elements in the delay line. In this way, the DLL provides negative feedback to help ensure that the total delay through the delay line is one VCO cycle.

In some implementations, synthesizer circuitry 3206D can be configured to generate a carrier frequency as the output frequency, while in other implementations, the output frequency can be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some implementations, the output frequency can be a LO frequency (fLO). In some implementations, RF circuitry 3206 can include an in-phase/quadrature (I/Q)/polar converter.

FEM circuitry 3208 can include a receive signal path which can include circuitry configured to operate on RF signals received from one or more antennas 3210, amplify the received signals and provide the amplified versions of the received signals to RF circuitry 3206 for further processing. FEM circuitry 3208 can also include a transmit signal path which can include circuitry configured to amplify signals for transmission provided by RF circuitry 3206 for transmission by one or more of the one or more antennas 3210. In various implementations, the amplification through the transmit or receive signal paths can be done solely in RF circuitry 3206, solely in FEM circuitry 3208, or in both RF circuitry 3206 and FEM circuitry 3208.

In some implementations, FEM circuitry 3208 can include a transmit/receive switch to switch between transmit mode and receive mode operation. FEM circuitry 3208 can include a receive signal path and a transmit signal path. The receive signal path of FEM circuitry 3208 can include a low noise amplifier to amplify received RF signals and provide the amplified received RF signals as an output (e.g., to RF circuitry 3206). The transmit signal path of FEM circuitry 3208 can include a power amplifier to amplify input RF signals (e.g., provided by RF circuitry 3206), and one or more filters to generate RF signals for subsequent transmission (e.g., by one or more of one or more antennas 3210).

In some implementations, PMC 3212 can manage power provided to baseband circuitry 3204. In particular, PMC 3212 can control power-source selection, voltage scaling, battery charging, or direct current (DC) to DC (DC-to-DC) conversion. PMC 3212 can often be included when device 3200 is capable of being powered by a battery, for example, when device 3200 is included in a UE. PMC 3212 can increase the power conversion efficiency while providing desirable implementation size and heat dissipation characteristics.

While FIG. 32 shows PMC 3212 coupled only with baseband circuitry 3204. However, in other implementations, PMC 3212 can be additionally or alternatively coupled with, and perform similar power management operations for, other components such as, but not limited to, application circuitry 3202, RF circuitry 3206, or FEM circuitry 3208.

In some implementations, PMC 3212 can control, or otherwise be part of, various power saving mechanisms of device 3200. For example, if device 3200 is in an RRC_Connected state, where device 3200 is still connected to the RAN node as device 3200 expects to receive traffic shortly, then device 3200 can enter a state known as discontinuous reception mode (DRX) after a period of inactivity. During this state, device 3200 can power down for brief intervals of time and thus save power.

If there is no data traffic activity for an extended period of time, then device 3200 can transition off to an RRC_Idle state, where device 3200 disconnects from the network and does not perform operations such as channel quality feedback, handover, etc. Device 3200 can go into a very low power state and device 3200 can perform paging where again device 3200 periodically can wake up to listen to the network and then power down again. Device 3200 may not receive data in this state; in order to receive data, device 3200 can transition back to RRC_Connected state.

An additional power saving mode can allow a device to be unavailable to the network for periods longer than a paging interval (ranging from seconds to a few hours). During this time, the device 3200 can be unreachable to the network and can power down completely. Any data sent during this time can incur a large delay and device 3200 can assume the delay is acceptable.

Processors of application circuitry 3202 and processors of baseband circuitry 3204 can be used to execute elements of one or more instances of a protocol stack. For example, processors of baseband circuitry 3204, alone or in combination, can be used execute Layer 3, Layer 2, or Layer 1 functionality, while processors of baseband circuitry 3204 can utilize data (e.g., packet data) received from these layers and further execute Layer 4 functionality (e.g., transmission communication protocol (TCP) and user datagram protocol (UDP) layers). As referred to herein, Layer 3 can comprise a radio resource control layer. As referred to herein, Layer 2 can comprise a medium access control layer, a radio link control layer, and a packet data convergence protocol layer, described in further detail below. As referred to herein, Layer 1 can comprise a physical layer of a UE/RAN node.

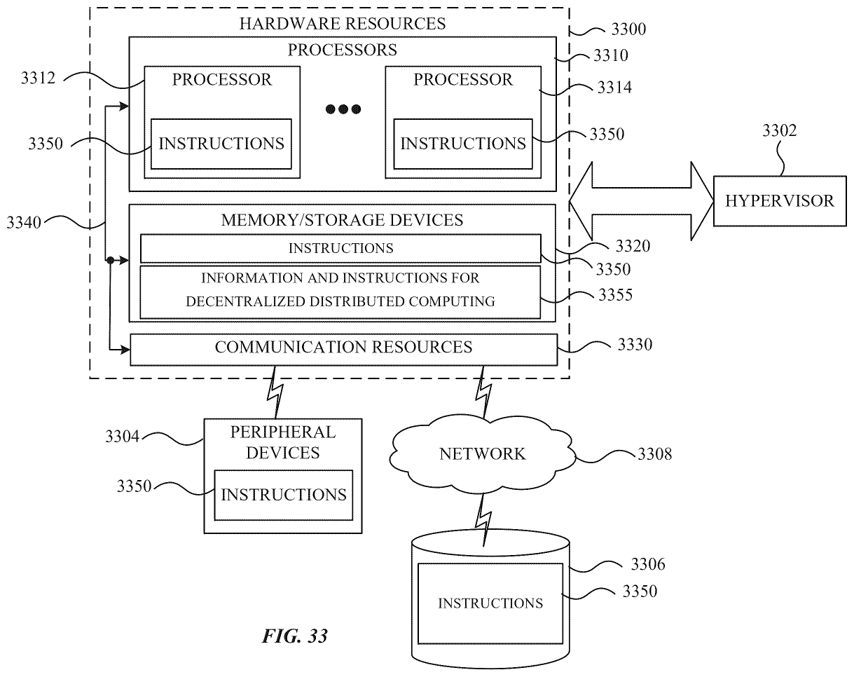

FIG. 33 is a block diagram illustrating components, according to some example implementations, able to read instructions from a machine-readable or computer-readable medium (e.g., a non-transitory machine-readable storage medium) and perform any one or more of the methodologies discussed herein. Specifically, FIG. 33 shows a diagrammatic representation of hardware resources 3300 including one or more processors (or processor cores) 3310, one or more memory/storage devices 3320, and one or more communication resources 3330, each of which can be communicatively coupled via a bus 3340. For implementations where node virtualization (e.g., NFV) is utilized, a hypervisor can be executed to provide an execution environment for one or more network slices/sub-slices to utilize the hardware resources 3300.

The processors 3310 (e.g., a central processing unit (CPU), a reduced instruction set computing (RISC) processor, a complex instruction set computing (CISC) processor, a graphics processing unit (GPU), a digital signal processor (DSP) such as a baseband processor, an application specific integrated circuit (ASIC), a radio-frequency integrated circuit (RFIC), another processor, or any suitable combination thereof) can include, for example, a processor 3312 and a processor 3314.

The memory/storage devices 3320 can include main memory, disk storage, or any suitable combination thereof. The memory/storage devices 3320 can include, but are not limited to any type of volatile or non-volatile memory such as dynamic random-access memory (DRAM), static random-access memory (SRAM), erasable programmable read-only memory (EPROM), electrically erasable programmable read-only memory (EEPROM), Flash memory, solid-state storage, etc.

In some implementations, memory/storage devices 3320 receive and/or store information and instructions 3355 for decentralized distributed computing within a wireless environment. A set of local wireless devices (e.g., UEs 210) can form a subnetwork with each other. UEs 210 can support various functions to enable compute tasks to be offloaded from come subnetwork devices and performed by other subnetwork devices. The result produced by performing the task can be returned to the device that offloaded the task. MN 310 of the subnetwork can connect to base station 222 and/or directly to an MN 310 of another subnetwork. Computing tasks can be offloaded from the subnetwork, performed by another subnetwork or a network device (such as base station 222 or a network server), and the results of the task performed can be returned to the subnetwork that offloaded the task. These and many other features are techniques are described in detail herein.

The communication resources 3330 can include interconnection or network interface components or other suitable devices to communicate with one or more peripheral devices 3304 or one or more databases 3306 via a network 3308. For example, the communication resources 3330 can include wired communication components (e.g., for coupling via a Universal Serial Bus (USB)), cellular communication components, NFC components, Bluetooth® components (e.g., Bluetooth® Low Energy), Wi-Fi® components, and other communication components.

Instructions 3350 can comprise software, a program, an application, an applet, an app, or other executable code for causing at least any of the processors 3310 to perform any one or more of the methodologies discussed herein. The instructions 3350 can reside, completely or partially, within at least one of the processors 3310 (e.g., within the processor's cache memory), the memory/storage devices 3320, or any suitable combination thereof. Furthermore, any portion of the instructions 3350 can be transferred to the hardware resources 3300 from any combination of the peripheral devices 3304 or the databases 1506. Accordingly, the memory of processors 1310, the memory/storage devices 1520, the peripheral devices 1504, and the databases 1506 are examples of computer-readable and machine-readable media.

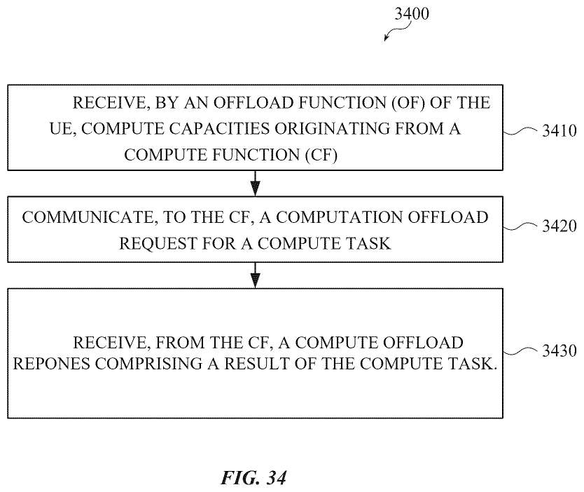

FIG. 34 is a diagram of a process 3400 for decentralized distributed computing according to one or more implementations described herein. Process 3400 can be implemented by UE 210. In some implementations, some or all of process 3400 can be performed by one or more other systems or devices, including one or more of the devices of FIG. 2. Additionally, process 3400 can include one or more fewer, additional, differently ordered and/or arranged operations than those shown in FIG. 34. In some implementations, some or all of the operations of process 3400 can be performed independently, successively, simultaneously, etc., of one or more of the other operations of process 3400. As such, the techniques described herein are not limited to the number, sequence, arrangement, timing, etc., of the operations or processes depicted in FIG. 34.

Process 3400 can include receiving, by an offload function (OF) of the UE, compute capacities originating from a compute function (CF) (block 3410). Process 3400 can include communicating, to the CF, a computation offload request for a compute task (block 3420). Process 3400 can include receiving, from the CF, a compute offload response comprising a result of the compute task (block 3430). The result can include a confirmation or a rejection response to the requested compute task.

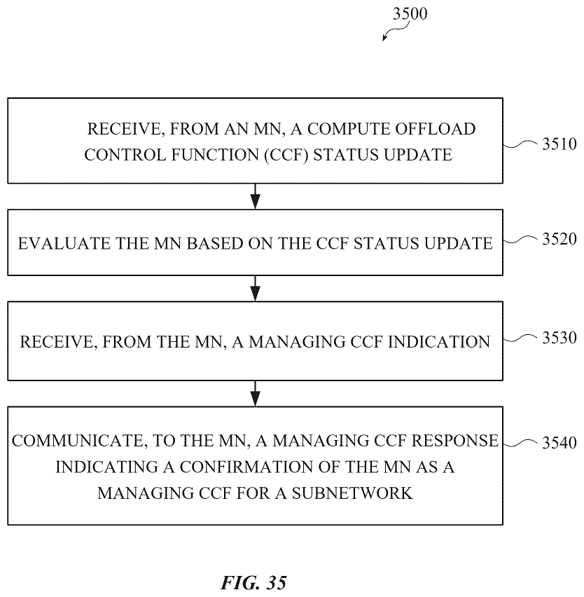

FIG. 35 is a diagram of a process 3500 for decentralized distributed computing according to one or more implementations described herein. Process 3500 can be implemented by UE 210. In some implementations, some or all of process 3500 can be performed by one or more other systems or devices, including one or more of the devices of FIG. 2. Additionally, process 3500 can include one or more fewer, additional, differently ordered and/or arranged operations than those shown in FIG. 35. In some implementations, some or all of the operations of process 3400 can be performed independently, successively, simultaneously, etc., of one or more of the other operations of process 3500. As such, the techniques described herein are not limited to the number, sequence, arrangement, timing, etc., of the operations or processes depicted in FIG. 35.

Process 3500 can include receiving, from an MN 310, a compute offload control function (CCF) status update (block 3510). Process 3500 can include evaluating the MN 310 based on the CCF status update (block 3520). Process 3500 can include receiving, from the MN 310, a managing CCF indication (block 3530). Process 3500 can include communicating, to the base station, a managing CCF response indicating a confirmation of the base station as a managing CCF for a subnetwork of the UE (block 3540).

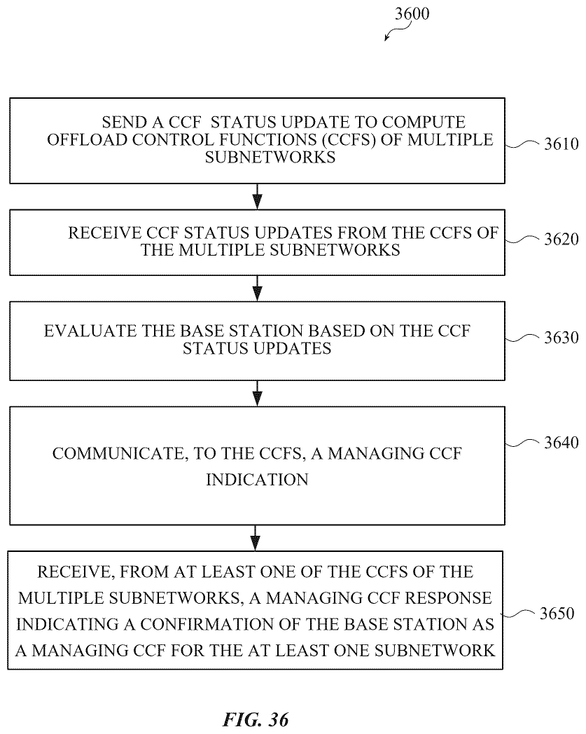

FIG. 36 is a diagram of a process 3600 for decentralized distributed computing according to one or more implementations described herein. Process 3600 can be implemented by base station 222. In some implementations, some or all of process 3600 can be performed by one or more other systems or devices, including one or more of the devices of FIG. 2. Additionally, process 3600 can include one or more fewer, additional, differently ordered and/or arranged operations than those shown in FIG. 36. In some implementations, some or all of the operations of process 3600 can be performed independently, successively, simultaneously, etc., of one or more of the other operations of process 3600. As such, the techniques described herein are not limited to the number, sequence, arrangement, timing, etc., of the operations or processes depicted in FIG. 36.

Process 3600 can include sending a CCF status update to compute offload control functions (CCFs) of multiple subnetworks (block 3610). Process 3600 can include receiving CCF status updates from the CCFs of the multiple subnetworks (block 3620). Process 3600 can include evaluating the base station based on the CCF status updates (block 3630). Process 3600 can include communicate, to the CCFs, a managing CCF indication (block 3640). Process 3600 can include receiving, from at least one of the CCFs of the multiple subnetworks, a managing CCF response indicating a confirmation of the base station as a managing CCF for the at least one subnetwork (block 3650).

Examples and/or implementations herein can include subject matter such as a method, means for performing acts or blocks of the method, at least one machine-readable medium including executable instructions that, when performed by a machine (e.g., a processor (e.g., processor, etc.) with memory, an application-specific integrated circuit (ASIC), a field programmable gate array (FPGA), or the like) cause the machine to perform acts of the method or of an apparatus or system for concurrent communication using multiple communication technologies according to implementations and examples described.

In example 1, which can also include one or more of the examples described herein, a user device (UE) can comprise: a memory; and one or more processors configured to, when executing instructions stored in the memory, cause the UE to: receive, by an offload function (OF) of the UE, compute capacities originating from a compute function (CF); communicate, to the CF, a computation offload request for a compute task; and receive, from the CF, a compute offload response comprising a confirmation or a rejection response to the requested compute task.

In example 2, which can also include one or more of the examples described herein, the compute capabilities are received via a compute offload control function (CCF).

In example 3, which can also include one or more of the examples described herein, the compute offload request is communicated to the CF via an update comprising the compute requirements of a CCF.

In example 4, which can also include one or more of the examples described herein, the compute offload request includes a CF identity (ID) associated with the CF.

In example 5, which can also include one or more of the examples described herein, a result of the compute task is received from the CF by the OF.

In example 6, which can also include one or more of the examples described herein, the compute capacities are received in response to communicating a compute capabilities status request to the CF and receiving a compute capabilities update in response thereto.

In example 7, which can also include one or more of the examples described herein, the UE is configured to operate as a managing CCF in response to receiving a managing CCF indication.

In example 8, which can also include one or more of the examples described herein, the UE is configured to operate as a supporting CCF in response to receiving a supporting CCF indication.

In example 9, which can also include one or more of the examples described herein, the UE is configured to confirm a managing CCF indication received from a CF.

In example 10, which can also include one or more of the examples described herein, the UE is configured to communicate a CCF status request to the CF and receive a CCF status update in response thereto.

In example 11, which can also include one or more of the examples described herein, the UE is a low capacity (LC) node of a subnetwork, and the CF corresponds to a HC node of the subnetwork, and the subnetwork is managed by a managing node (MN).

In example 12, which can also include one or more of the examples described herein, a user device (UE), comprising: a memory; and one or more processors configured to, when executing instructions stored in the memory, cause the UE to: receive, from a managing node (MN), a compute offload control function (CCF) status update; evaluate the MN based on the CCF status update; receive, from the MN, a managing CCF indication; and communicate, to the MN, a managing CCF response indicating a confirmation of the MN as a managing CCF for a subnetwork of the UE.

In example 13, which can also include one or more of the examples described herein, the UE is configured to communicate a CCF status update to the MN and receive the CCF status update in response thereto.

In example 14, which can also include one or more of the examples described herein, the UE is configured to communicate a CCF status request to the MN and receive the CCF status update in response thereto.

In example 15, which can also include one or more of the examples described herein, the managing CCF is configured to enable decentralized distributed computing between the subnetwork of the UE and another subnetwork via the managing CCF of the MN.

In example 16, which can also include one or more of the examples described herein, a base station, comprising: a memory; and one or more processors configured to, when executing instructions stored in the memory, cause the base station to: send a CCF status update to compute offload control functions (CCFs) of multiple subnetworks; receive CCF status updates from the CCFs of the multiple subnetworks; evaluate the base station based on the CCF status updates; communicate, to the CCFs, a managing CCF indication; and receive, from at least one of the CCFs of the multiple subnetworks, a managing CCF response indicating a confirmation of the base station as a managing CCF for the at least one subnetwork.

In example 17, which can also include one or more of the examples described herein, the base station is configured to receive at least one managing CCF response indicating a rejection of the base station as a managing CCF.

In example 18, which can also include one or more of the examples described herein, the base station is configured to operate as the managing CCF for the at least one of the CCFs of the multiple subnetworks.

In example 19, which can also include one or more of the examples described herein, the CCF status updates from the CCFs of the multiple subnetworks comprise CCF status requests.

In example 20, which can also include one or more of the examples described herein, the managing CCF is configured to enable decentralized distributed computing between the multiple subnetworks.

In example 21, which can also include one or more of the examples described herein, a method comprising operations according to one or more of the examples described herein.

In example 22, which can also include one or more of the examples described herein, a computer-readable medium comprising one or more instructions that when executed by one or more processors cause the one or more processors to perform according to one or more of the examples described herein.

In example 23, which can also include one or more of the examples described herein, a baseband processor comprising: a memory; and one or more processors configured to, when executing instructions stored in the memory, cause the base band processors to perform according to one or more of the examples described herein.

In example 24, which can also include one or more of the examples described herein, a method can comprise receiving, from a managing node (MN), a compute offload control function (CCF) status update; evaluating the MN based on the CCF status update; receiving, from the MN, a managing CCF indication; and communicating, to the MN, a managing CCF response indicating a confirmation of the MN as a managing CCF for a subnetwork of the UE.

In example 25, which can also include one or more of the examples described herein, a method can comprise communicating a CCF status update to the MN and receive the CCF status update in response thereto.

In example 26, which can also include one or more of the examples described herein, a method can comprise communicating a CCF status request to the MN and receive the CCF status update in response thereto.

In example 27, which can also include one or more of the examples described herein, decentralized distributed computing is enabled between the subnetwork of the UE and another subnetwork via the managing CCF of the MN.

The examples discussed above also extend to method, computer-readable medium, and means-plus-function claims and implementations, an of which can include one or more of the features or operations of any one or combination of the examples mentioned above.

The above description of illustrated examples, implementations, aspects, etc., of the subject disclosure, including what is described in the Abstract, is not intended to be exhaustive or to limit the disclosed aspects to the precise forms disclosed. While specific examples, implementations, aspects, etc., are described herein for illustrative purposes, various modifications are possible that are considered within the scope of such examples, implementations, aspects, etc., as those skilled in the relevant art can recognize.

In this regard, while the disclosed subject matter has been described in connection with various examples, implementations, aspects, etc., and corresponding Figures, where applicable, it is to be understood that other similar aspects can be used or modifications and additions can be made to the disclosed subject matter for performing the same, similar, alternative, or substitute function of the subject matter without deviating therefrom. Therefore, the disclosed subject matter should not be limited to any single example, implementation, or aspect described herein, but rather should be construed in breadth and scope in accordance with the appended claims below.

In particular regard to the various functions performed by the above described components or structures (assemblies, devices, circuits, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations. In addition, while a particular feature can have been disclosed with respect to only one of several implementations, such feature can be combined with one or more other features of the other implementations as can be desired and advantageous for any given application.

As used herein, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. Furthermore, to the extent that the terms “including”, “includes”, “having”, “has”, “with”, or variants thereof are used in either the detailed description or the claims, such terms are intended to be inclusive in a manner similar to the term “comprising.” Additionally, in situations wherein one or more numbered items are discussed (e.g., a “first X”, a “second X”, etc.), in general the one or more numbered items can be distinct, or they can be the same, although in some situations the context can indicate that they are distinct or that they are the same.

It is well understood that the use of personally identifiable information should follow privacy policies and practices that are generally recognized as meeting or exceeding industry or governmental requirements for maintaining the privacy of users. In particular, personally identifiable information data should be managed and handled to minimize risks of unintentional or unauthorized access or use, and the nature of authorized use should be clearly indicated to users.

What is claimed is:

1. A user device (UE), comprising:
a memory; and
one or more processors configured to, when executing instructions stored in the memory, cause the UE to:
receive, by an offload function (OF) of the UE, compute capabilities originating from a compute function (CF);
communicate, to the CF, a computation offload request for a compute task; and
receive, from the CF, a compute offload response comprising a confirmation or a rejection response to the compute task.

2. The UE of claim 1, wherein the compute capabilities are received via a compute offload control function (CCF).

3. The UE of claim 1, wherein the compute offload request is communicated to the CF via an update comprising compute requirements of a CCF.

4. The UE of claim 1, wherein the compute offload request includes a CF identity (ID) associated with the CF.

5. The UE of claim 1, wherein a result of the compute task is received from the CF by the OF.

6. The UE of claim 1, wherein the compute capabilities are received in response to communicating a compute capabilities status request to the CF and receiving a compute capabilities update in response thereto.

7. The UE of claim 1, wherein the UE is configured to operate as a managing CCF in response to receiving a managing CCF indication.

8. The UE of claim 1, wherein the UE is configured to operate as a supporting CCF in response to receiving a supporting CCF indication.

9. The UE of claim 1, wherein the UE is configured to confirm a managing CCF indication received from the CF.

10. The UE of claim 1, wherein the UE is configured to communicate a CCF status request to the CF and receive a CCF status update in response thereto.

11. The UE of claim 1, wherein the UE is a low capacity (LC) node of a subnetwork, and the CF corresponds to a HC node of the subnetwork, and the subnetwork is managed by a managing node (MN).

12. A method, performed by a user device (UE), comprising:
receiving, from a managing node (MN), a compute offload control function (CCF) status update;
evaluating the MN based on the CCF status update;
receiving, from the MN, a managing CCF indication; and
communicating, to the MN, a managing CCF response indicating a confirmation of the MN as a managing CCF for a subnetwork of the UE.

13. The method of claim 12, further comprising:
communicating a CCF status update to the MN and receive the CCF status update in response thereto.

14. The method of claim 12, further comprising:
communicating a CCF status request to the MN and receive the CCF status update in response thereto.

15. The method of claim 12, wherein decentralized distributed computing is enabled between the subnetwork of the UE and another subnetwork via the managing CCF of the MN.

16. A base station, comprising:
a memory; and
one or more processors configured to, when executing instructions stored in the memory, cause the base station to:
send a CCF status update to compute offload control functions (CCFs) of multiple subnetworks;
receive CCF status updates from the CCFs of the multiple subnetworks;
evaluate the base station based on the CCF status updates;
communicate, to the CCFs, a managing CCF indication; and
receive, from at least one of the CCFs of the multiple subnetworks, a managing CCF response indicating a confirmation of the base station as a managing CCF for at least one subnetwork.

17. The base station of claim 16, wherein the base station is configured to receive at least one managing CCF response indicating a rejection of the base station as a managing CCF.

18. The base station of claim 16, wherein the base station is configured to operate as the managing CCF for the at least one of the CCFs of the multiple subnetworks.

19. The base station of claim 16, wherein the CCF status updates from the CCFs of the multiple subnetworks comprise CCF status requests.

20. The base station of claim 16, wherein the managing CCF is configured to enable decentralized distributed computing between the multiple subnetworks.
